(19) United States
(12) Patent Application Publication
(10) Pub. No.: US 2026/0312658 A1
(43) Pub. Date: Oct. 8, 2026

(54) RADIO ACCESS NETWORK NODE, UE, NETWORK NODE, AND METHODS THEREFOR

(71) Applicant: NEC Corporation, Minato-ku, Tokyo (JP)

(72) Inventors: Hisashi FUTAKI, Tokyo (JP); Sadafuku HAYASHI, Tokyo (JP)

(73) Assignee: NEC Corporation, Minato-ku, Tokyo (JP)

(21) Appl. No.: 18/875,190

(22) PCT Filed: Jul. 7, 2023
(86) PCT No.: PCT/JP2023/025338

§ 371 Date: Dec. 16, 2024

(30) Foreign Application Priority Data
Jul. 26, 2022 (JP) 2022-118616

(51) Int. Cl. H04B 7/06; H04W 24/10; H04W 84/06

(52) U.S. Cl. CPC H04B 7/0695; H04W 24/10; H04W 84/06

(57) ABSTRACT

A first RAN node (501) sends to a second RAN node (502), in a mobility-related procedure or dual connectivity-related procedure with respect to a User Equipment (UE) (3), planned path information indicating a plurality of planned locations of the UE (3). For example, this can provide improved signaling for mobility-related or dual-connectivity-related procedures.

### TECHNICAL FIELD

The present disclosure relates to radio communication systems, and in particular to signaling between radio access network nodes regarding mobility or dual connectivity for a radio terminal.

### BACKGROUND ART

The 3rd Generation Partnership Project (3GPP (registered trademark)) Release 15 and later releases support Aerial User Equipment (UE) communications (see, for example, Non-Patent Literature 1-4). As described in Non-Patent Literature 1, section 23.17, under the current 3GPP specification, Evolved Universal Terrestrial Radio Access Network (EUTRAN) based mechanisms providing Long Term Evolution (LTE) connectivity to UEs capable of aerial communication are supported via the following functionalities:
subscription-based aerial UE identification and authorization;
height reporting based on the event that the UE's altitude has crossed a network-configured reference altitude threshold;
interference detection based on a measurement reporting that is triggered when a configured number of cells (i.e. larger than one) fulfills a triggering criteria simultaneously;
signalling of flight path information from a UE to a E-UTRAN;
location information reporting, including UE's horizontal and vertical velocity.

For flight path information signaling, an E-UTRAN can request a UE to report flight path information including a number of waypoints defined as three-dimensional (3D) locations. The UE reports up to the number of waypoints configured in the request, if flight path information is available at the UE. The report can include a time stamp per waypoint if configured in the request and available in the UE.

Section 4.3.31 of Non-Patent Literature 2 specifies as follows. An eNodeB supporting aerial UE function handling uses the per-user information supplied by a Mobility Management Entity (MME) to determine whether or not to allow a UE to use the aerial UE function. Support of the aerial UE function is stored in the user's subscription information in a Home Subscriber Server (HSS). The HSS transfers this information to the MME via an Update Location message during attach and tracking area update procedures. The home operator may revoke the user's subscription authorisation for operating aerial UEs at any time. The MME supporting the aerial UE function provides the user's subscription information regarding the aerial UE authorisation to the eNodeB via an S1 AP Initial Context Setup Request during attach, tracking area update, and service request procedures.

For intra-MME and inter-MME S1-based handover (intra RAT) or inter-RAT handover to E-UTRAN, the aerial UE subscription information for the user is included in an S1 Application Protocol (S1AP) UE Context Modification Request message sent to the target eNodeB after the handover procedure. On the other hand, for X2-based handover, the aerial UE subscription information for the user is sent to the target eNodeB as follows. If the source eNodeB supports the aerial UE function and the user's aerial UE subscription information is included in the UE context, the source eNodeB shall include the information in an X2AP Handover Request message to the target eNodeB. The MME shall send the aerial UE subscription information to the target eNodeB in a Path Switch Request Acknowledge message.

If the aerial UE subscription information has changed, the updated aerial UE subscription information is included in an S1AP UE Context Modification Request message sent by the MME to the eNodeB.

Sections 5.3.3, 5.3.5, 5.3.7, and 5.6.5 of Non-Patent Literature 3 specify as follows. If the UE has flight path information available, the UE informs the E-UTRTAN in a Radio Resource Control (RRC) connection establishment, RRC connection reconfiguration, or RRC connection re-establishment that flight path information is available. Specifically, the UE may include a flightPathInfoAvailable field set to the value true in an RRC Connection Setup Complete message, an RRC Connection Resume Complete message, an RRC Connection Reconfiguration Complete message, and an RRC Connection Reestablishment Complete message.

The E-UTRTAN may use a UE Information procedure to request the UE to report information. Specifically, the E-UTRTAN can send a UE Information Request message to the UE containing a flightPathInfoReq field. The flightPathInfoReq field indicates a FlightPathInfoReportConfig Information Element (IE). The FlightPathInfoReportConfig IE specifies the maximum number of waypoints that the UE can include in a flight path information report. In addition, the FlightPathInfoReportConfig IE optionally indicates whether a time stamp for each waypoint can be reported in the flight path information report if time stamp information is available at the UE. For these purposes, the FlightPathInfoReportConfig IE includes a max Way PointNumber field and an includeTimeStamp field.

If the flightPathInfoReq field is present in the UE Information Request message and the UE has available flight path information, the UE includes a flightPathInfoReport field in a UE Information Response message and sends the UE Information Response message to the E-UTRTAN. The flightPathInfoReport field contains a FlightPathInfoReport IE. The FlightPathInfoReport IE specifies a sequence of Way PointLocation IEs. Each Way PointLocation IE contains a way PointLocation field and optionally a timeStamp field. The way PointLocation field contains location coordinates for the UE for aerial UE operations. The waypoints describe planned (or scheduled) locations of the UE. The timeStamp field contains time stamps for the waypoints that describe planned locations of the UE.

Non-Patent Literature 4 specifies as follows. Section 8.2.1.2 describes that if an Aerial UE subscription information IE is included in an X2AP Handover Request message received from the source eNB, the target eNB shall, if supported, store this information in the UE context and use it as defined in 3GPP TS 36.300 (Non-Patent Literature 1). Section 9.1.1.1 describes that the Handover Request message optionally includes an Aerial UE subscription information IE. Section 9.2.129 describes that the Aerial UE subscription information IE is used by the eNodeB (eNB) to know if the UE is allowed to use the aerial UE function. It also describes that the Aerial UE subscription information IE is of an enumerated type, indicating “allowed” or “not allowed”.

3GPP Release 18 will support similar features to those described above for providing New Radio (NR) communications to aerial UEs (see, for example, Non-Patent Literature 3).

Patent Literature 1 describes handover of a mobile station (UE). More specifically, in the handover described in Patent Literature 1, the target control apparatus (e.g., base station, eNodeB) receives a request message from the source control apparatus indicating a target cell as the handover destination of the UE. If the handover request to the target cell is not acceptable, the target control apparatus may respond to the source control apparatus with a handover acknowledge response message indicating another cell that is acceptable for handover and is different from the target cell. In other words, the target control apparatus informs the source control apparatus via the handover acknowledge response message that it can accept a handover to a cell not specified in the handover request message from the source control apparatus.

### CITATION LIST

### Patent Literature

[Patent Literature 1] WO 2011/018890 A1

### Non Patent Literature

[Non-Patent Literature 1] 3GPP TS 36.300 V 17.0.0 (2022-03), “3rd Generation Partnership Project; Technical Specification Group Radio Access Network; Evolved Universal Terrestrial Radio Access (E-UTRA) and Evolved Universal Terrestrial Radio Access Network (E-UTRAN); Overall description; Stage 2 (Release 17)”, April 2022
[Non-Patent Literature 2] 3GPP TS 23.401 V 17.5.0 (2022-06), “3rd Generation Partnership Project; Technical Specification Group Services and System Aspects; General Packet Radio Service (GPRS) enhancements for Evolved Universal Terrestrial Radio Access Network (E-UTRAN) access (Release 17)”, June 2022
[Non-Patent Literature 3] 3GPP TS 36.331 V 17.0.0 (2022-03), “3rd Generation Partnership Project; Technical Specification Group Radio Access Network; Evolved Universal Terrestrial Radio Access (E-UTRA); Radio Resource Control (RRC); Protocol specification (Release 17)”, April 2022
[Non-Patent Literature 4] 3GPP TS 36.423 V 17.1.0 (2022-06), “3rd Generation Partnership Project; Technical Specification Group Radio Access Network; Evolved Universal Terrestrial Radio Access Network (E-UTRAN); X2 application protocol (X2AP) (Release 17)”, June 2022
[Non-Patent Literature 5] Nokia, “New WID on NR support for UAV (Uncrewed Aerial Vehicles)”, RP-213600, 3GPP TSG-RAN Meeting #94e, Dec. 6-17, 2021

### SUMMARY OF INVENTION

### Technical Problem

The inventors have studied mobility of aerial UEs and dual connectivity for aerial UEs and found problems. One problem is that the current 3GPP specification does not require the source Radio Access Network (RAN) node to provide flight path information to the target RAN node in UE mobility-related procedures. Similarly, the current 3GPP specification does not require the Master Node (MN) to provide flight path information to the Secondary Node (SN), or vice versa, in dual connectivity-related procedures.

In this context, UE mobility may be, but is not limited to, handover or conditional handover. For dual connectivity, UE mobility can be an inter-MN handover, a Master Node to eNB/gNB Change, or an eNB/gNB to Master Node Change. A dual connectivity-related procedure may be, but is not limited to, an SN addition procedure, a conditional SN addition procedure, a SN change procedure, or a conditional SN change procedure. A (conditional) SN addition procedure may be referred to as a (conditional) Primary Secondary Cell Group (SCG) Cell (PSCell) addition procedure. Similarly, a (conditional) SN change procedure may be referred to as a (conditional) inter-SN PSCell change procedure. The dual connectivity-related procedures described above can be said to be included in UE mobility in a broad sense, as they involve the addition or modification of one or more serving cells of the UE. Accordingly, the term mobility or mobility-related procedures, as defined herein, may refer inclusively to handover procedures and the dual connectivity-related procedures described above.

For example, in a handover or conditional handover, the source RAN node (e.g., gNB) or a controller associated with the source RAN node (e. g., Near-Real-Time RAN Intelligent Controller (Near-RT RIC)) is expected to consider the UE's flight path information to determine a target cell, resulting in handover optimization. However, it is difficult for the source RAN node to map the 3D location information specified in the flight path information to the actual coverage of one or more target (candidate) cells, and thus the flight path information may not be fully utilized effectively. Similar problems exist with respect to dual connectivity. For example, it may be difficult for the MN to map the 3D location information specified in the flight path information to the actual coverage of one or more candidate PSCells provided by the SN.

Another problem is that the current 3GPP specification does not require the MN to send the aerial UE subscription information to the SN with respect to dual connectivity. It may be useful for the SN to be able to use the aerial UE subscription information to determine whether to perform aerial UE-related operations.

A further problem is that in the current 3GPP specification, the execution conditions for conditional mobility are not based on the flight path information. In other words, the conditional mobility execution conditions are not related to the planned flight path of an aerial UE. The flight path information may be taken into account to provide conditional mobility execution conditions suitable for aerial UEs. Here, conditional mobility includes, for example but not limited to, conditional handover, conditional PSCell Addition (CPA), intra-SN conditional PSCell change (CPC), or inter-SN CPC. Conditional mobility may be referred to as conditional reconfiguration. CPA, intra-SN CPC, and inter-SN CPC for dual connectivity may be referred to as conditional dual connectivity procedures or conditional dual connectivity-related procedures.

As a still further problem, it may be useful to allow a handover as described in Patent Literature 1, involving the suggestion of an alternative target cell by the target node, only under specific circumstances or conditions where it would be useful to do so. Patent Literature 1 does not provide such specific circumstances or conditions.

Note that some or all of the multiple problems described above may occur not only in cases where aerial UE flight path information is used, but also in other cases. For example, these problems may also arise in cases where travel path information is available for UEs implemented in land-based vehicles. A land-based vehicle, also referred to as a land vehicle or ground vehicle, is a type of vehicle that travels on land or the ground. The travel path information for a land-based vehicle describes the planned or scheduled locations of the land-based vehicle. These locations can be two-dimensional (2D) locations. The term “planned path information” is used in this specification to mean information that describes planned or scheduled locations of a UE or a vehicle, airborne vehicle, or mobile robot in which a UE is implemented, such as flight path information and travel path information.

One of the objects to be achieved by the example embodiments disclosed herein seek to achieve is to provide apparatuses, methods, and programs that contribute to solving at least one of a plurality of problems, including the problems described above. It should be noted that this object is only one of the objects to be achieved by the example embodiments disclosed herein. Other objects or problems and novel features will become apparent from the following description and the accompanying drawings.

### Solution to Problem

A first aspect is directed to a first radio access network (RAN) node. The first RAN node includes at least one memory and at least one processor coupled to the at least one memory. The at least one processor is configured to send to a second RAN node, in a mobility related procedure or a dual connectivity-related procedure with respect to a UE, planned path information indicating a plurality of planned locations of the UE.

A second aspect is directed to a method performed by a first RAN node. The method includes sending to a second RAN node, in a mobility-related procedure or a dual connectivity-related procedure with respect to a UE, planned path information indicating a plurality of planned locations of the UE.

A third aspect is directed to a second RAN node. The second RAN node includes at least one memory and at least one processor coupled to the at least one memory. The at least one processor is configured to receive from a first RAN node, in a mobility-related procedure or a dual connectivity-related procedure with respect to a UE, planned path information indicating a plurality of planned locations of the UE.

A fourth aspect is directed to a method performed by a second RAN node. The method includes receiving from a first RAN node, in a mobility-related procedure or a dual connectivity-related procedure with respect to a UE, planned path information indicating a plurality of planned locations of the UE.

A fifth aspect is directed to a RAN node configured to operate as an MN in dual connectivity for a UE. The RAN node includes at least one memory and at least one processor coupled to the at least one memory. The at least one processor is configured to send planned path information indicating a plurality of planned locations of the UE to an SN of the dual connectivity.

A sixth aspect is directed to a method performed by a RAN node configured to operate as an MN in dual connectivity for a UE. The method includes sending planned path information indicating a plurality of planned locations of the UE to an SN of the dual connectivity.

A seventh aspect is directed to a RAN node configured to operate as an SN in dual connectivity for a UE. The RAN node includes at least one memory and at least one processor coupled to the at least one memory. The at least one processor is configured to receive planned path information indicating a plurality of planned locations of the UE from an MN of the dual connectivity.

An eighth aspect is directed to a method performed by a RAN node configured to operate as an SN in dual connectivity for a UE. The method includes receiving planned path information indicating a plurality of planned locations of the UE from an MN of the dual connectivity.

A ninth aspect is directed to a RAN node configured to operate as an MN in dual connectivity for a UE. The RAN node includes at least one memory and at least one processor coupled to the at least one memory. The at least one processor is configured to receive planned path information indicating a plurality of planned locations of the UE from an SN of the dual connectivity.

A tenth aspect is directed to a method performed by a RAN node configured to operate as an MN in dual connectivity for a UE. The method includes receiving planned path information indicating a plurality of planned locations of the UE from an SN of the dual connectivity.

An eleventh aspect is directed to a RAN node configured to operate as an SN in dual connectivity for a UE. The RAN node includes at least one memory and at least one processor coupled to the at least one memory. The at least one processor is configured to send planned path information indicating a plurality of planned locations of the UE to an MN of the dual connectivity.

A twelfth aspect is directed to a method performed by a RAN node configured to operate as an SN in dual connectivity for a UE. The method includes sending planned path information indicating a plurality of planned locations of the UE to an MN of the dual

A thirteenth aspect is directed to a RAN node configured to operate as an MN in dual connectivity for a UE. The RAN node includes at least one memory and at least one processor coupled to the at least one memory. The at least one processor is configured to send aerial UE subscription information regarding the UE or information derived therefrom to a secondary node (SN) of the dual connectivity.

A fourteenth aspect is directed to a method performed by a RAN node configured to operate as an MN in dual connectivity for a UE. The method includes sending aerial UE subscription information regarding the UE or information derived therefrom to a secondary node (SN) of the dual connectivity.

A fifteenth aspect is directed to a RAN node configured to operate as an SN in dual connectivity for a UE. The RAN node includes at least one memory and at least one processor coupled to the at least one memory. The at least one processor is configured to receive aerial UE subscription information regarding the UE or information derived therefrom from an MN of the dual connectivity.

A sixteenth aspect is directed to a method performed by a RAN node configured to operate as an SN in dual connectivity for a UE. The method includes receiving aerial UE subscription information regarding the UE or information derived therefrom from an MN of the dual connectivity.

A seventeenth aspect is directed to a RAN node. The RAN node includes at least one memory and at least one processor coupled to the at least one memory. The at least one processor is configured to determine one or more execution conditions for conditional mobility of a UE based on planned path information indicating a plurality of planned locations of the UE.

An eighteenth aspect is directed to a method performed by a RAN node. The method includes determining one or more execution conditions for conditional mobility of a UE based on planned path information indicating a plurality of planned locations of the UE.

A nineteenth aspect is directed to a RAN node. The RAN node includes at least one memory and at least one processor coupled to the at least one memory. The at least one processor is configured to receive from a source RAN node a handover request of a UE indicating one or more target cells. The at least one processor is configured to, if the handover request includes one or both of planned path information indicating a plurality of planned locations of the UE and an explicit indication that an alternative cell proposal is allowed, send a handover request response to the source RAN node indicating another cell that is acceptable for handover and is different from the one or more target cells.

A twentieth aspect is directed to a method performed by a RAN node. The method includes the steps of:
(a) receive from a source RAN node a handover request of a UE indicating one or more target cells; and
(b) if the handover request includes one or both of planned path information indicating a plurality of planned locations of the UE and an explicit indication that an alternative cell proposal is allowed, sending a handover request response to the source RAN node indicating another cell that is acceptable for handover and is different from the one or more target cells.

A twenty-first aspect is directed to a program. The program includes a set of instructions (software code) that, when read into a computer, causes the computer to perform the method according to the second, fourth, sixth, eighth, tenth, twelfth, fourteenth, sixteenth, eighteenth, or twentieth aspect described above.

### Advantageous Effects of Invention

According to the aspects described above, it is possible to provide apparatuses, methods, and programs that contribute to solving at least one of a plurality of problems, including the problems described above.

### BRIEF DESCRIPTION OF DRAWINGS

FIG. 1 shows an example configuration of a radio communication system according to an example embodiment;

FIG. 2 shows an example configuration of a radio communication system according to an example embodiment;

FIG. 3 shows an example configuration of a radio communication system according to an example embodiment;

FIG. 4 shows an example configuration of a RAN node according to an example embodiment;

FIG. 5 is a sequence diagram showing an example of signaling between RAN nodes according to an example embodiment;

FIG. 6 shows a flowchart showing an example operation of a RAN node according to an example embodiment;

FIG. 7 shows a flowchart showing an example operation of a RAN node according to an example embodiment;

FIG. 8 shows a flowchart showing an example operation of a RAN node according to an example embodiment;

FIG. 9 shows a flowchart showing an example operation of a RAN node according to an example embodiment;

FIG. 10 shows an example of the format of a HandoverPreparationInformation message according to an example embodiment;

FIG. 11 shows an example of the format of a HANDOVER REQUEST message according to an example embodiment;

FIG. 12 shows an example of the format of a CG-ConfigInfo message according to an example embodiment;

FIG. 13 shows an example of the format of an S-NODE ADDITION REQUEST message according to an example embodiment;

FIG. 14 is a sequence diagram showing an example of dual connectivity-related signaling between RAN nodes according to an example embodiment;

FIG. 15 is a sequence diagram showing an example of dual connectivity-related signaling between RAN nodes according to an example embodiment;

FIG. 16 is a sequence diagram showing an example of dual connectivity-related signaling between RAN nodes according to an example embodiment;

FIG. 17 shows an example of the format of an S-NODE ADDITION REQUEST message according to an example embodiment;

FIG. 18 shows a flowchart showing an example operation of a RAN node according to an example embodiment;

FIG. 19 is a sequence diagram showing an example of handover-related signaling between RAN nodes according to an example embodiment;

FIG. 20 is a sequence diagram showing an example of handover-related signaling between RAN nodes according to an example embodiment;

FIG. 21 is a block diagram showing an example configuration of a RAN node according to an example embodiment; and

FIG. 22 is a block diagram showing an example configuration of a UE according to an example embodiment.

### EXAMPLE EMBODIMENT

Specific example embodiments will be described hereinafter in detail with reference to the drawings. Identical or corresponding elements are designated by the same symbols throughout the drawings, and duplicate explanations are omitted where necessary for the sake of clarity.

The multiple example embodiments described below may be implemented independently or in any suitable combination. These multiple example embodiments have novel features that differ from one another. Accordingly, these multiple example embodiments contribute to achieving different objectives or solving different problems and contribute to achieving different advantages.

The following example embodiments are described primarily with respect to the 3GPP Long Term Evolution (LTE) system and the 5th generation mobile communication system (5G system). However, these example embodiments can be applied to other radio communication systems that support technologies similar to 3GPP mobility-related procedures or dual connectivity-related procedures. The term LTE as used herein includes improvements and enhancements to LTE and LTE-Advanced to enable interworking with 5G systems, unless otherwise specified.

As used in this specification, “if” can be interpreted to mean “when”, “at or around the time”, “after”, “upon”, “in response to determining”, “in accordance with a determination”, or “in response to detecting”, depending on the context. These expressions can be interpreted to mean the same thing, depending on the context.

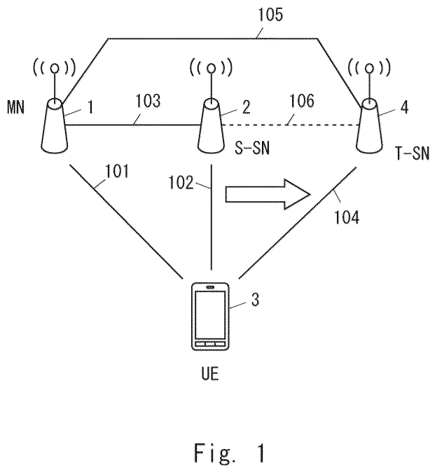

First, the configuration and operation of a plurality of network elements common to a plurality of example embodiments are described. FIG. 1 shows an example configuration of a radio communication system according to a plurality of example embodiments. In the example of FIG. 1, the radio communication system includes a RAN node 1, a RAN node 2, a RAN node 4, and a UE 3. Each element (or network function) shown in FIG. 1 can be implemented, for example, as a network element on dedicated hardware, as a software instance running on dedicated hardware, or as a virtualized function instantiated on an application platform.

The RAN node 1 may be a Central Unit (e. g., eNB-CU or gNB-CU) in a Cloud RAN (C-RAN) deployment, or a combination of a CU and one or more Distributed Units (e. g., eNB-DUs or gNB-DUs). The C-RAN is also referred to as a CU/DU split. The CU may include a Control Plane (CP) Unit (e.g., gNB-CU-CP) and one or more User Plane (UP) Units (e.g., gNB-CU-UPs). Accordingly, the RAN node 1 may be a CU-CP or a combination of a CU-CP and a CU-UP(s). Similarly, each of the RAN nodes 2 and 4 may be a CU or a combination of a CU and one or more DUs. Each of the RAN nodes 2 and 4 may be a CU-CP or a combination of a CU-CP and a CU-UP(s).

Each of the RAN nodes 1, 2, and 4 may be an Evolved Universal Terrestrial Radio Access Network (E-UTRAN) node or a Next Generation Radio Access Network (NG-RAN) node. The E-UTRAN node may be an eNB or an en-gNB. The NG-RAN node may be a gNB or an ng-eNB. The en-gNB is a node that provides NR user plane and control plane protocol terminations towards a UE and acts as an SN in E-UTRA-NR Dual Connectivity (EN-DC). The ng-eNB is a node that provides E-UTRA user plane and control plane protocol terminations towards a UE and is connected to a 5GC via an NG interface. The Radio Access Technology (RAT) of the RAN node 1 may be different from that of the RAN nodes 2 and 4.

The RAN node 1 and the RAN node 2 communicate with each other through an inter-node interface (i.e., X2 interface or Xn interface) 103. The RAN node 1 and the RAN node 2 operate as a MN and an SN, respectively, in dual connectivity. In addition, the RAN node 1 and the RAN node 4 communicate with each other through an inter-node interface (i.e., X2 interface or Xn interface) 105. The RAN node 1 and the RAN node 4 can operate as an MN and an SN, respectively, in DC. An inter-node interface (i.e., X2 interface or Xn interface) 106 may be configured between the RAN node 2 and the RAN node 4.

The RAN nodes 1, 2, and 4 and the UE 3 support inter-SN CPC from an SCG provided by the RAN node 2 to an SCG provided by the RAN node 4. Accordingly, in the following, the RAN node 1 may be referred to as MN 1, the RAN node 2 may be referred to as source SN (S-SN) 2, and the RAN node 4 may be referred to as target SN (T-SN) 4, candidate SN 4, or target candidate SN 4. Inter-SN CPC may also be referred to as conditional SN change.

Inter-SN CPC (or conditional SN change) is an inter-SN PSCell change (or SN change) procedure that is executed only if one or more CPC execution conditions are met or satisfied. The UE 3 maintains a connection to the source SN 2 and source SCG even after receiving an SN change instruction from the MN 1 and starts to evaluate the configured execution condition(s) configured by the instruction. The UE 3 then starts to access the candidate target SN 4 and the selected candidate PSCell in response to the fulfillment of the execution condition(s).

Inter-SN CPC can be initiated by the MN 1 or by the source SN 2. Inter-SN CPC initiated by the MN 1 is referred to as MN-initiated inter-SN CPC. On the other hand, inter-SN CPC initiated by the source SN 2 is referred to as SN-initiated inter-SN CPC. In MN-initiated inter-SN CPC, the MN 1 generates CPC execution conditions. In contrast, in SN-initiated inter-SN CPC, the source SN 2 generates CPC execution conditions and sends them to the MN 1. In both MN-initiated inter-SN CPC and SN-initiated inter-SN CPC, the candidate target SN 4 generates an SCG configuration and sends it to the MN 1. The MN 1 then sends a CPC configuration (e.g., ConditionalReconfiguration IE) containing both the CPC execution conditions and the SCG configuration to the UE 3 via an RRC (Connection) Reconfiguration message.

Although not shown in FIG. 1, a plurality of candidate cells (i.e., candidate PSCells) provided by a plurality of candidate SNs 4 may be prepared for an inter-SN CPC. In the inter-SN CPC procedure, the UE 3 receives, from the MN 1, configurations of one or more candidate PSCells (i.e., one or more SCG configurations) prepared by one or more candidate SNs and one or more CPC execution conditions associated therewith. More specifically, the configuration of each candidate PSCell is included in an information element (e.g., condRRCReconfig) of an RRC message of the MN 1, and the configurations of one or more candidate PSCells and the associated CPC execution conditions are included in conditional mobility configuration information (e.g., conditionalReconfiguration IE) generated by the MN 1.

The configuration of each candidate PSCell (i.e., SCG configuration) is generated by the candidate SN (e.g., candidate SN 4) that provides (or has prepared) that candidate PSCell. The configuration of each candidate PSCell includes at least configuration information for the candidate PSCell. The configuration of each candidate PSCell may further include configuration information for one or more SCells that accompany (i.e., are configured together with or in association with) the candidate PSCell. The configuration of each candidate PSCell may be a radio bearer (RB) configuration, a cell group (CG) configuration, an SCG configuration, or an SCG radio resource configuration, or any combination thereof. More specifically, the configuration of each candidate PSCell may be an SN RRC Reconfiguration message generated by the candidate SN (e.g., candidate SN 4) that provides (or has prepared) that candidate PSCell. Part or all of the configurations of one or more candidate PSCells are contained in a CPC configuration sent from the MN 1 to the UE 3. The CPC configuration of an inter-SN CPC includes a list of one or more MN RRC Reconfiguration messages, and associated execution conditions. Each MN RRC Reconfiguration message contains the configuration of a candidate PSCell (e.g., one or any combination of RB configuration, CG configuration, SCG configuration, SCG radio resource configuration, and SN RRC Reconfiguration message) received from the candidate SN.

On the other hand, CPC execution conditions are generated by the MN 1 in the case of MN-initiated inter-SN CPC or by the source SN 2 in the case of SN-initiated inter-SN CPC. A CPC execution condition may consist of one or more trigger conditions. A condition or criterion that triggers a CPC event may be similar to that for a measurement report event and may be, for example, CondEvent B1, CondEvent A3, CondEvent A4, or CondEvent A5. CondEvent B1 is “Conditional reconfiguration candidate becomes better than absolute threshold”. CondEvent A3 is “Conditional reconfiguration candidate becomes amount of offset better than PCell/PSCell”. CondEvent A4 is “Conditional reconfiguration candidate becomes better than absolute threshold”. CondEvent A5 is “PCell/PSCell becomes worse than absolute threshold1 AND Conditional reconfiguration candidate becomes better than another absolute threshold2”. The UE 3 evaluates the CPC execution conditions. If the execution condition(s) for one candidate PSCell is (or are) met, the UE 3 applies the PSCell configuration (e.g., one or any combination of RB configuration, CG configuration, SCG configuration, SCG radio resource configuration, and SN RRC Reconfiguration message) corresponding to the selected candidate PSCell (i.e., the candidate PSCell whose execution condition(s) is (or are) satisfied). If a bearer requiring SCG radio resources is configured, the UE 3 performs synchronization with the selected PSCell. If the execution conditions for two or more candidate PSCells are satisfied, the UE 3 may select one of these candidate PSCells and perform the operation described above.

The UE 3 communicates with the MN 1 and the S-SN 2 via the air interfaces 101 and 102 and performs dual connectivity of the MCG provided by the MN 1 and the SCG provided by the S-SN 2. In addition, by performing an inter-SN CPC, the UE 3 communicates with the MN 1 and the T-SN 4 via the air interfaces 101 and 104 and performs dual connectivity of the MCG provided by the MN 1 and the SCG provided by the T-SN 4.

This dual connectivity may be Multi-Radio Dual Connectivity (MR-DC). The MR-DC includes E-UTRA-NR Dual Connectivity (EN-DC), NG-RAN E-UTRA-NR Dual Connectivity (NGEN-DC), NR-E-UTRA Dual Connectivity (NE-DC), and NR-NR Dual Connectivity (NR-DC). Accordingly, the MN 1 may be one of a Master eNB (in EN-DC), a Master ng-eNB (in NGEN-DC), and a Master gNB (in NR-DC and NE-DC). Similarly, each of the S-SN 2 and the T-SN 4 may be one of an en-gNB (in EN-DC), a Secondary ng-eNB (in NE-DC), and a Secondary gNB (in NR-DC and NGEN-DC). In EN-DC, the UE 3 is connected to an eNB acting as the MN 1 and to an en-gNB acting as the S-SN 2 or the T-SN 4. In NGEN-DC, the UE 3 is connected to an ng-eNB acting as the MN 1 and to a gNB acting as the S-SN 2 or the T-SN 4. In NE-DC, the UE 3 is connected to a gNB acting as the MN 1 and to an ng-eNB acting as the S-SN 2 or the T-SN 4. In NR-DC, the UE 3 is connected to one gNB (or gNB-DU) acting as the MN 1 and to another gNB (or gNB-DU) acting as the S-SN 2 or the T-SN 4.

The MCG is a group of serving cells associated with (or provided by) the MN 1, including the SpCell (i.e., Primary Cell (PCell)) and optionally one or more Secondary Cells (SCells). Meanwhile, the SCG is a group of serving cells associated with (or provided by) the S-SN 2 or the T-SN 4 and includes the Primary SCG Cell (PSCell) and optionally one or more Secondary Cells (SCells). The PSCell is the Special Cell (SpCell) of the SCG and supports Physical Uplink Control Channel (PUCCH) transmission and contention-based random access. In LTE (e. g., LTE-DC and NE-DC), PSCell may be an abbreviation of Primary SCell.

As used in the present specification, the term “primary SCG cell” and its abbreviation “PSCell” stands for a cell that is included in a cell group provided by an SN in dual connectivity, has an uplink component carrier, and is configured with uplink control channel (e.g., PUCCH) resources. Specifically, the term “primary SCG cell” and its abbreviation “PSCell” may refer to a Primary SCG Cell of a cell group provided by an SN (e. g., en-gNB in EN-DC, gNB in NGEN-DC, or gNB in NR-DC) supporting 5G NR, or may refer to a Primary SCell of a cell group provided by an SN (e.g., eNB in LTE DC, or ng-eNB in NE-DC) supporting E-UTRA.

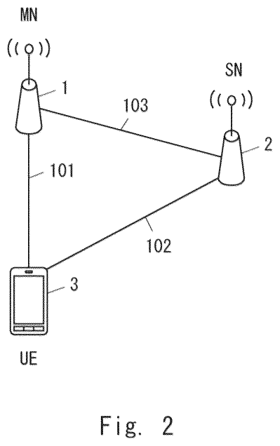

FIG. 2 shows another example configuration of a radio communication system according to a plurality of example embodiments. In the example in FIG. 2, the radio communication system includes a RAN node 1, a RAN node 2, and a UE 3. Each element (or network function) shown in FIG. 2 can be implemented, for example, as a network element on dedicated hardware, as a software instance running on dedicated hardware, or as a virtualized function instantiated on an application platform.

The RAN node 1, RAN node 2, and UE 3 in the example in FIG. 2 may have a similar configuration and functionality to those in the example in FIG. 1. Specifically, the RAN node 1 and the RAN node 2 communicate with each other through an inter-node interface (i.e., X2 interface or Xn interface) 103. The RAN node 1 and the RAN node 2 operate as an MN and a SN, respectively, in dual connectivity. The UE 3 communicates with the MN 1 and the SN 2 via air interfaces 101 and 102 and performs dual connectivity of an MCG and an SCG. This dual connectivity may be Multi-Radio Dual Connectivity (MR-DC).

The RAN nodes 1 and 2 and the UE 3 support Conditional PSCell Addition (CPA) to add an SCG provided by the RAN node 2 for the UE 3. Accordingly, in the following, the RAN node 1 may be referred to as MN 1 and the RAN node 2 may be referred to as candidate SN 2. CPA may be referred to as conditional SN addition. CPA (or conditional SN addition) is a PSCell addition (or SN addition) procedure that is performed only if a CPA execution condition is met.

CPA (or conditional SN addition) is a PSCell addition (or SN addition) procedure that is executed only if one or more CPA execution conditions are met or satisfied. After the UE 3 receives a PSCell addition instruction from the MN 1, it starts evaluation of the configured execution condition(s) for one or more candidate PSCells configured by the instruction. Then, in response to the fulfilment of the execution condition(s) for one of the candidate PSCells, the UE 3 initiates synchronization with that PSCell. In CPA, the MN 1 generates CPA execution conditions. The candidate SN 2 generates an SCG configuration and sends it to the MN 1. The MN 1 sends a CPA configuration (e.g., ConditionalReconfiguration IE) containing both the CPA execution conditions and the SCG configuration to the UE 3 via an RRC (Connection) Reconfiguration message.

Although not shown in FIG. 2, a plurality of candidate PSCells provided by a plurality of candidate SNs 2 may be prepared for a CPA. In the CPA procedure, the UE 3 receives, from the MN 1, configurations of one or more candidate PSCells (i.e., one or more SCG configurations) prepared by one or more candidate SNs and one or more CPA execution conditions associated therewith. More specifically, the configuration of each candidate PSCell is included in an information element (e.g., condRRCReconfig) of an RRC message of the MN 1, and the configurations of one or more candidate PSCells and the associated CPA execution conditions are included in conditional mobility configuration information (e.g., conditionalReconfiguration IE) generated by the MN 1.

The configuration of each candidate PSCell is generated by the candidate SN (e.g., candidate SN 2) that provides (or has prepared) that candidate PSCell. The configuration of each candidate PSCell includes at least configuration information for the candidate PSCell. The configuration of each candidate PSCell may further include configuration information for one or more SCells that accompany (i.e., are configured together with or in association with) the candidate PSCell. The configuration of each candidate PSCell may be one or any combination of an RB configuration, a CG configuration, an SCG configuration, and an SCG radio resource configuration. More specifically, the configuration of each candidate PSCell may be an SN RRC Reconfiguration message generated by the candidate SN (e.g., candidate SN 4) that provides (or has prepared) that candidate PSCell. Part or all of the configurations of one or more candidate PSCells are contained in a CPA configuration sent from the MN 1 to the UE 3. The CPA configuration includes a list of one or more MN RRC Reconfiguration messages, and associated execution conditions. Each MN RRC Reconfiguration message contains the configuration of a candidate PSCell (e.g., one or any combination of RB configuration, CG configuration, SCG configuration, SCG radio resource configuration, and SN RRC Reconfiguration message) received from the candidate SN.

On the other hand, CPA execution conditions are generated by the MN 1. A CPA execution condition may consist of one or more trigger conditions. A condition or criterion that triggers a CPA event may be similar to that for a measurement report event and may be, for example, CondEvent A3, CondEvent A4, or CondEvent A5. The UE 3 evaluates the CPA execution conditions. If the execution condition(s) for one candidate PSCell is (or are) met, the UE 3 applies the PSCell configuration (i.e., CG configuration, SCG configuration, SCG radio resource configuration, or SN RRC Reconfiguration message) corresponding to the selected candidate PSCell (i.e., the candidate PSCell whose execution condition(s) is (or are) satisfied). If a bearer requiring SCG radio resources is configured, the UE 3 performs synchronization with the selected PSCell. If the execution conditions for two or more candidate PSCells are satisfied, the UE 3 may select one of these candidate PSCells and perform the operation described above.

In addition, the RAN node 2 and the UE 3 support intra-SN CPC. Intra-SN CPC may be referred to as SN-initiated Conditional SN Modification without MN involvement. Intra-SN CPC is an intra-SN PSCell change procedure that is performed only if a CPC execution condition is met.

In the intra-SN CPC procedure, the UE 3 receives from the SN 2, configurations of one or more candidate PSCells prepared by the SN 2 and one or more CPC execution conditions associated therewith. The configurations and associated CPC execution conditions for respective candidate PSCells are contained in a CPC configuration of the intra-SN CPC. The SN 2 may send these to the UE 3 via the MN 1 or to the UE 3 via a direct signaling radio bearer (i.e., Signalling Radio Bearer 3 (SRB3)) between the SN 2 and the UE 3. More specifically, the configuration of each candidate PSCell is an Information Element (IE) (e.g., condRRCReconfig) of an RRC message of the SN 2, and the configurations of one or more candidate PSCells and the associated CPC execution conditions are included in conditional mobility configuration information (e.g., conditionalReconfiguration IE) generated by the SN 2.

The configuration of each candidate PSCell includes at least configuration information for the candidate PSCell. The configuration £ of each candidate PSCell may further include configuration information for one or more SCells that accompany (i.e., are configured together with or in association with) the candidate PSCell. The configuration of each candidate PSCell may be a radio bearer (RB) configuration, a cell group (CG) configuration, an SCG configuration, or an SCG radio resource configuration, or any combination thereof. In particular, the configuration of each candidate PSCell may be an SN RRC Reconfiguration message generated by the SN 2.

A CPC execution condition for an Intra-SN CPC may consist of one or more trigger conditions. A condition or criterion that triggers a CPC event may be similar to that for a measurement report event and may be, for example, CondEvent A3, CondEvent A4, or CondEvent A5. The UE 3 evaluates the CPC execution conditions. If the execution condition(s) for one candidate PSCell is (or are) met, the UE 3 detaches from the source PSCell, applies the configuration corresponding to the selected candidate PSCell (i. e., the candidate PSCell whose execution condition(s) is (or are) satisfied), and synchronizes with the selected candidate PSCell. If the execution conditions for two or more candidate PSCells are satisfied, the UE 3 may select one of these candidate PSCells and perform the operation described above.

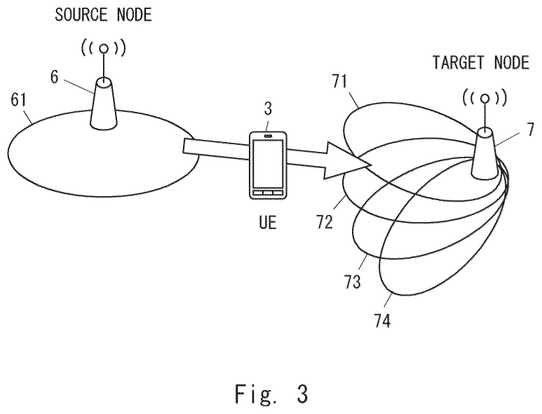

FIG. 3 shows yet another example configuration of a radio communication system according to a plurality of example embodiments. In the example in FIG. 3, the radio communication system includes a RAN node 6, a RAN node 7, and a UE 3. Each element (or network function) shown in FIG. 3 can be implemented, for example, as a network element on dedicated hardware, as a software instance running on dedicated hardware, or as a virtualized function instantiated on an application platform. Each of the RAN nodes 6 and 7 may be an EUTRAN node or an NG-RAN node. The EUTRAN node may be an eNB or an en-gNB. The NG-RAN node may be a gNB or an ng-eNB. The RAT of the RAN node 6 may be different from that of the RAN node 7.

The RAN node 6 provides at least one cell 61. The RAN node 7 provides one or more cells (e. g., four cells 71-74). In the example in FIG. 3, the cell 61 provided by the RAN node 6 is the current serving cell of the UE 3, and the UE 3 is handed over from the cell 61 to one of the cells provided by the RAN node 7. Accordingly, in the following, the RAN node 6 may be referred to as the source node or source RAN node, and the RAN node 7 may be referred to as the target node or target RAN node. The cell 61 is referred to as the source cell. The source node 6, the target node 7, and the UE 3 support conditional handover (CHO). CHO is a handover procedure that is performed only if a CHO execution condition is met.

Although not shown in FIG. 3, a plurality of candidate target cells provided by a plurality of candidate target nodes 7 may be prepared for a CHO. In the CHO procedure, the UE 3 receives from the source node 6 configurations of one or more candidate target cells prepared by one or more candidate target nodes and one or more CHO execution conditions (e.g., condExecutionCond) associated therewith. The configurations of one or more candidate target cells and the associated CHO execution conditions are contained in a CHO configuration. More specifically, the configuration of each candidate target cell is an Information Element (IE) (e.g., condRRCReconfig) of an RRC message of the source node 6, and the configurations of one or more candidate target cells and the associated CHO execution conditions are included in conditional mobility configuration information (e.g., conditionalReconfiguration IE) generated by the source node 6.

The configuration of each candidate target cell is generated by the candidate target node (e.g., target node 7) that provides (or has prepared) that candidate target cell. The configuration of each candidate target cell may be one or any combination of a radio bearer (RB) configuration, a radio resource configuration, and an RRC Reconfiguration message, generated by the candidate target node (e. g., target node 7) that provides (or has prepared) that candidate target cell.

On the other hand, CHO execution conditions are generated by the source node 6. A CHO execution condition may consist of one or more trigger conditions. A condition or criterion that triggers a CHO event may be similar to that for a measurement report event and may be, for example, CondEvent A3, CondEvent A4, or CondEvent A5. The UE 3 evaluates the CHO execution conditions. If the execution condition(s) for one candidate target cell is (or are) met, the UE 3 detaches from the source node 6, applies the configuration corresponding to the selected candidate target cell (i.e., the candidate target cell whose execution condition(s) is (or are) satisfied), and synchronizes with the selected candidate target cell. If the execution conditions for two or more candidate target cells are satisfied, the UE 3 may select one of these candidate target cells and perform the operation described above.

The CHO may be inter-MN (inter-MN) handover, Master Node to eNB/gNB Change, or eNB/gNB to Master Node Change, in dual connectivity.

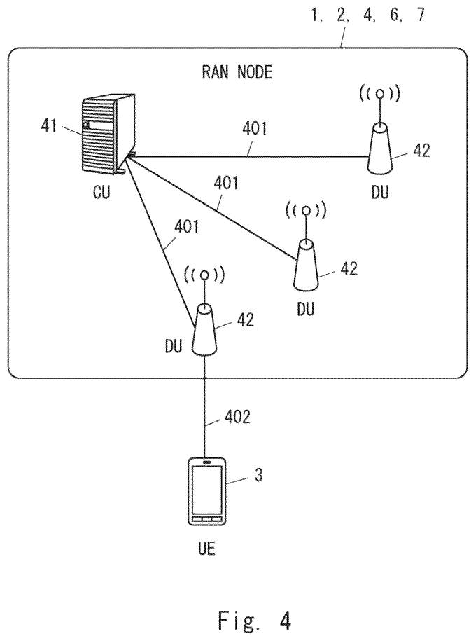

One or more of the RAN nodes 1, 2, 4, 6, and 7 may have the configuration shown in FIG. 4. Each element (or network function) shown in FIG. 4 can be implemented, for example, as a network element on dedicated hardware, as a software instance running on dedicated hardware, or as a virtualized function instantiated on an application platform. One or more of the RAN nodes 1, 2, 4, 6, and 7 may include, without limitation, a CU 41 and one or more DUs 42 as shown in FIG. 4. The CU 41 is connected to each DU 42 via an interface 401. The UE 3 is connected to at least one DU 42 via at least one air interface 402.

The CU 41 can be a logical node hosting the RRC, Service Data Adaptation Protocol (SDAP), and Packet Data Convergence Protocol (PDCP) protocols of the gNB (or the RRC and PDCP protocols of the gNB). The DU 42 can be a logical node hosting the Radio Link Control (RLC), Medium Access Control (MAC), and Physical (PHY) layers of the gNB. If the CU 41 is a gNB-CU and the DUs 42 are gNB-DUs, the interfaces 401 can be F1 interfaces. The CU 41 can include a CU-CP and a CU-UP.

The term “conditional mobility” is used herein. As explained above, conditional mobility is a generic term that refers to one or more of, for example, but not limited to, CHO, CPA, intra-SN CPC (or conditional SN modification), and inter-SN CPC (or conditional SN change). Conditional mobility may be referred to as conditional reconfiguration. CPA, intra-SN CPC, and inter-SN CPC for dual connectivity may be referred to as conditional dual connectivity procedures or conditional dual connectivity related procedures.

While the above description with reference to FIGS. 1 to 3 is primarily concerned with conditional mobility, the RAN nodes and UEs described in these drawings also support unconditional mobility, i.e., normal UE mobility, as a matter of course. As described above, the term “mobility” or “mobility-related procedures”, as defined herein, may refer inclusively to conditional and unconditional handover procedures and conditional and unconditional dual-connectivity procedures.

The terms “MN RRC Message”, “MN RRC (Connection) Reconfiguration Message”, “SN RRC Message”, and “SN RRC Reconfiguration Message” are used herein. These terms are used for convenience only to distinguish RRC messages generated by the MN from RRC messages generated by the SN. Accordingly, MN RRC messages and MN RRC (Connection) Reconfiguration messages may be referred to simply as RRC messages and RRC Reconfiguration messages (or RRC Connection Reconfiguration messages). Similarly, SN RRC messages and SN RRC Reconfiguration messages may be referred to simply as RRC messages and RRC Reconfiguration messages.

The UE 3 described with reference to FIGS. 1 to 4 may be an aerial UE. An aerial UE is a UE that supports aerial UE communications or is capable of aerial communications. An aerial UE may be a UE implemented in an unmanned or uncrewed aerial vehicle (UAV). In this case, the UE 3 may provide functions and operations as described in Non-Patent Literature 1 to 3 that should be supported by an LTE aerial UE. The UE 3 may be an NR aerial UE providing functions and operations similar to those provided by an LTE aerial UE. Similarly, the RAN (e.g., RAN nodes 1, 2, 4, 6, and 7) may provide functions and operations as described in Non-Patent Literature 1 to 3 that should be supported by an E-UTRAN to provide LTE connectivity to aerial UEs. The RAN may be an NG-RAN providing functions and operations similar to those provided by an E-UTRAN to support aerial UE communications. For example, the RAN (e.g., RAN node 1, 2, 4, 6, or 7) may request the UE 3 to report flight path information including a number of waypoints defined as 3D locations. If the flight path information is available in the UE 3, the UE 3 reports a configured number of waypoints. The report can include a time stamp for each waypoint if configured in the request and available in the UE 3.

The example embodiments described below provide improved signaling between RAN nodes regarding UE mobility or dual connectivity.

### First Example Embodiment

This example embodiment provides improved inter-RAN node signalling in UE mobility-related procedures or dual connectivity related procedures. An example configuration of a radio communication system in this example embodiment may be the same as any of the configuration examples described with reference to FIGS. 1 to 4.

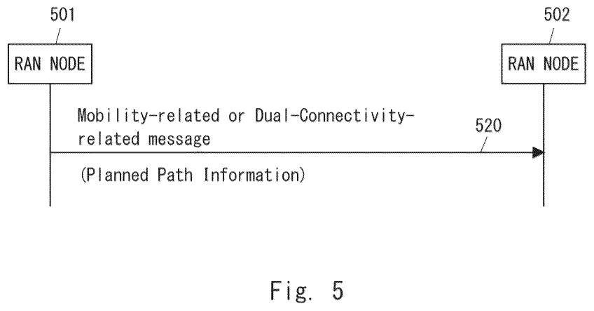

FIG. 5 shows an example of inter-RAN node signaling. In step 520, a RAN node 501 sends planned path information with respect to a UE 3 to a RAN node 502 in a mobility-related procedure or a dual connectivity-related procedure with respect to the UE 3. In other words, the RAN node 501 sends a mobility-related or dual connectivity-related message containing planned path information of the UE 3 to the RAN node 502. The planned path information may be information reported by the UE 3 to the RAN node 501 at the request of the RAN node 501. Prior to step 520, the RAN node 501 may receive the planned path information from the UE 3. The planned path information indicates planned or scheduled locations of the UE. These locations may be 3D locations or 2D locations. In an example, the planned path information may be related to an aerial UE (i.e., UE 3 with aerial UE capabilities) and may be flight path information that includes waypoints defined as 3D locations. In another example, the planned path information may describe planned or scheduled 2D locations of the UE 3 embedded in a land-based vehicle or mobile robot.

The mobility-related procedure may be a handover procedure or a conditional handover (CHO) procedure. The RAN nodes 501 and 502 may be the source RAN node (e. g., RAN node 6) and the target RAN node (e.g., RAN node 7) of a handover or CHO, respectively. In this case, the message in step 520 carrying the planned path information may be a HANDOVER REQUEST message. The planned path information may be contained in an inter-node RRC message. More specifically, the RAN node 501 may send the planned path information to the RAN node 502 via an inter-node RRC message in a HANDOVER REQUEST message. In general, an inter-node RRC message is an RRC message that is sent between RAN nodes via an inter-node interface such as the X2 or Xn interface.

The dual connectivity-related procedure may be an SN addition procedure, a conditional SN addition (or CPA) procedure, an SN change procedure, or a conditional SN change (or inter-SN CPC) procedure. The RAN nodes 501 and 502 may be the MN and the SN in an SN addition procedure or a conditional SN addition procedure, respectively. The RAN nodes 501 and 502 may be the MN and the target SN in an SN change procedure or a conditional SN change procedure, respectively. In these cases, the message in step 520 carrying the planned path information may be an S-NODE ADDITION REQUEST message. Alternatively, the RAN nodes 501 and 502 may be the source SN and the MN in an SN change procedure or a conditional SN change procedure, respectively. In this case, the message in step 520 may be an S-NODE CHANGE REQUIRED message.

According to the signaling described with reference to FIG. 5, the RAN node 501 provides the other RAN nodes 502 with planned path information for the UE 3 in a mobility-related or dual connectivity related procedure for the UE 3. This allows the RAN node 502, for example, to use the planned path information to optimize the (conditional) handover or (conditional) dual connectivity procedure for the UE 3.

The RAN node 502 may use the received planned path information for various purposes. For example, the RAN node 502 may predict or determine the current or future location(s) of the UE 3 by considering the planned locations of the UE 3 and optionally a time stamp per location. The RAN node 502 may consider the location(s) of the UE 3, predicted or determined based on the planned path information, in various decisions regarding the mobility of the UE 3. Examples of such applications are described below.

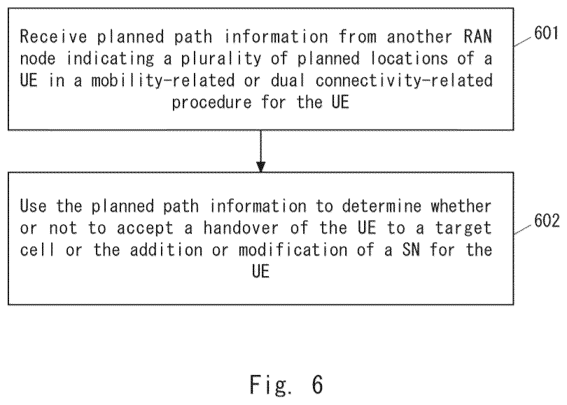

FIG. 6 shows a first example of the operation of the RAN node 502. Step 601 corresponds to step 520 in FIG. 5. Specifically, the RAN node 502 receives planned path information from the other RAN node 501 indicating a plurality of planned locations of the UE 3 in a mobility-related or dual connectivity-related procedure for the UE 3.

In step 602, the RAN node 502 uses the received planned path information to determine whether to accept a (conditional) handover of the UE 3 to a target cell or a (conditional) SN addition or change for the UE 3. For example, the RAN node 502 may predict or determine the current or future location(s) of the UE 3, taking into account the planned locations of the UE 3 and optionally a time stamp per location. The RAN node 502 may consider the location(s) of the UE 3 predicted or determined based on the planned path information to determine whether or not to accept a (conditional) handover requested by the RAN node 501. If the requested (candidate) target cell covers the predicted or determined location of the UE 3, the RAN node 502 may accept the (conditional) handover. Additionally or alternatively, the RAN node 502 may consider the location(s) of the UE 3 predicted or determined based on the planned path information to determine whether or not to accept a (conditional) SCG addition or change requested by the RAN node 501. If the requested (candidate) PSCell covers the predicted or determined location of the UE 3, the RAN node 502 may accept the (conditional) SCG addition or change.

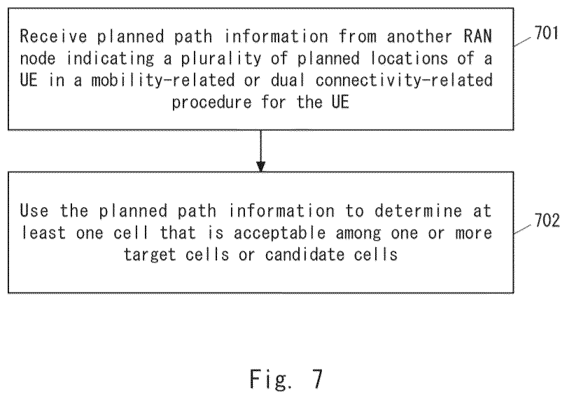

FIG. 7 shows a second example of the operation of the RAN node 502. Step 701 is similar to step 601 in FIG. 6. In step 702, the RAN node 502 uses the received planned path information to determine at least one cell that is acceptable among one or more target cells or candidate cells. For example, the RAN node 502 may predict or determine the current or future location(s) of the UE 3, taking into account the planned locations of the UE 3 and optionally a time stamp per location. The RAN node 502 may accept at least one cell that covers or surrounds the predicted or determined location of the UE 3.

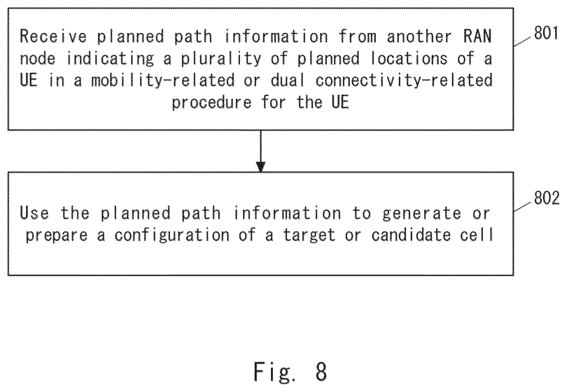

FIG. 8 shows a third example of the operation of the RAN node 502. Step 801 is similar to step 601 in FIG. 6. In step 802, the RAN node 502 uses the planned path information to generate or prepare a configuration of a target or candidate cell. For example, the RAN node 502 may predict or determine the current or future location(s) of the UE 3, taking into account the planned locations of the UE 3 and optionally a time stamp per location. The RAN node 502 may generate a target or candidate cell configuration (e.g., serving cell configuration, MCG configuration, SCG configuration) considering the predicted or determined location of the UE 3.

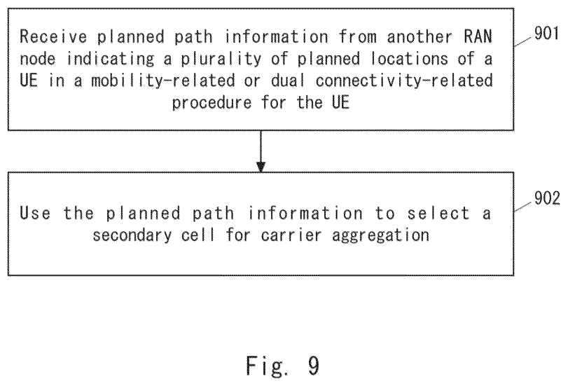

FIG. 9 shows a fourth example of the operation of the RAN node 502. Step 901 is similar to step 601 in FIG. 6. In step 902, the RAN node 502 uses the planned path information to select a secondary cell for carrier aggregation. In other words, the RAN node 502 uses the planned path information to determine one or more secondary cells (SCells) within the MCG or SCG. For example, the RAN node 502 may predict or determine the current or future location(s) of the UE 3, taking into account the planned locations of the UE 3 and optionally a time stamp per location. The RAN node 502 may select at least one cell that covers or surrounds the predicted or determined location of the UE 3 as a secondary cell.

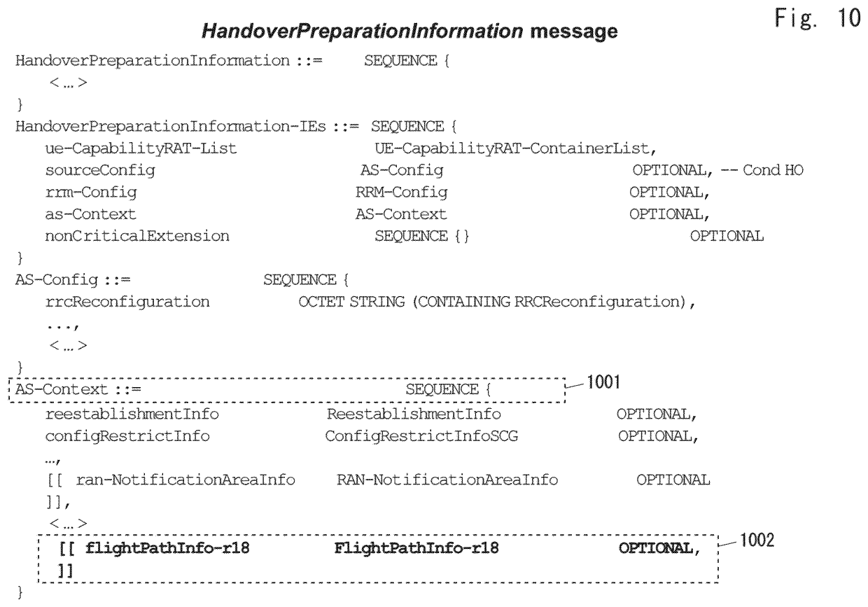

The following are some specific examples of the message of step 520. FIG. 10 shows an example of the format of a HandoverPreparationInformation message, which is an inter-node RRC message. The HandoverPreparationInformation message can be sent from the source RAN node (e. g., RAN node 6 or 501) to the target RAN node (e.g., RAN node 7 or 502) via a HANDOVER REQUEST message. In the example in FIG. 10, the HandoverPreparationInformation message may contain a flightPathInfo information element or field 1002 within an AS-Context information element or field 1001. The flightPathInfo information element or field 1002 specifies location coordinates representing planned or scheduled locations of the UE. The flightPathInfo information element or field 1002 optionally specifies a time stamp per location.

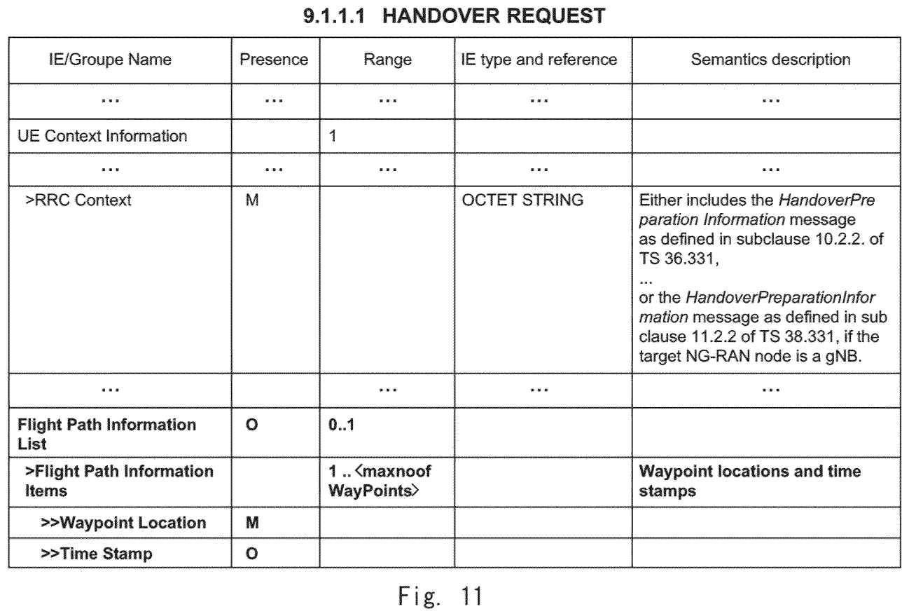

FIG. 11 shows an example of the format of a HANDOVER REQUEST message. In the example in FIG. 11, the HANDOVER REQUEST message optionally includes a new information element, “Flight Path Information List”. The Flight Path Information List IE contains Flight Path Information Items IEs up to a specified maximum number. A Flight Path Information Items IE includes a Waypoint Location IE and optionally a Time Stamp IE. The Waypoint Location IE indicates location coordinates of a planned UE location. The Time Stamp IE indicates a time stamp per location.

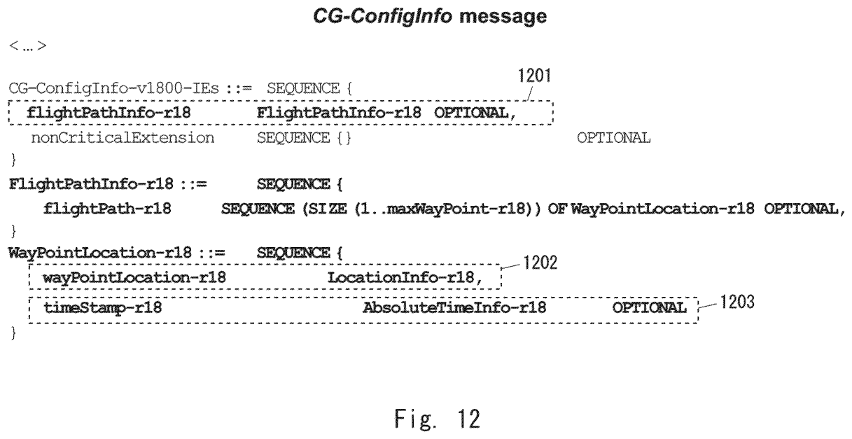

FIG. 12 shows an example of the format of a CG-ConfigInfo message, which is an inter-node RRC message. The CG-ConfigInfo message can be sent from the MN (e.g., MN 1 or RAN node 501) to the SN (e.g., SN 2, SN4, or RAN node 502) via an S-NODE ADDITION REQUEST message. In the example in FIG. 12, the CG-ConfigInfo message may contain a flightPathInfo information element or field 1201. The flightPathInfo information element or field 1201 specifies location coordinates (1202) representing planned or scheduled locations of the UE. The flightPathInfo information element or field 1201 optionally specifies a time stamp per location (1203).

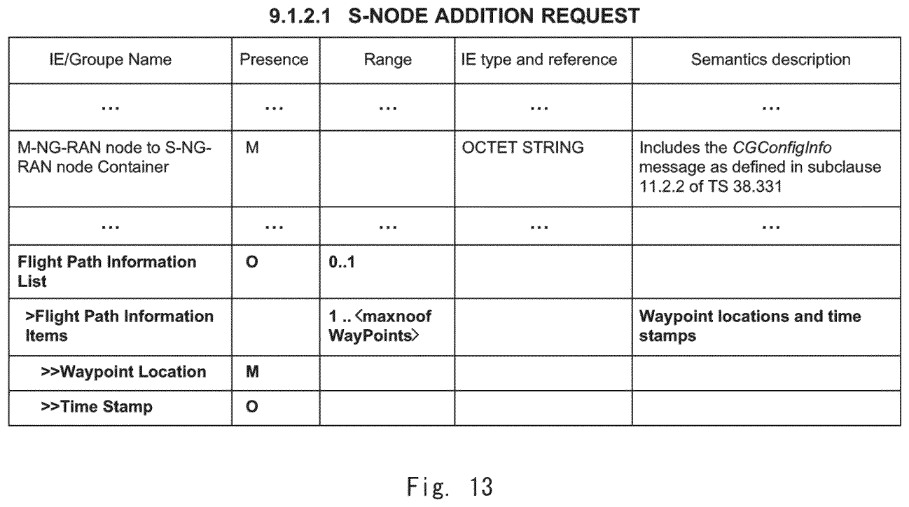

FIG. 13 shows an example of the format of an S-NODE ADDITION REQUEST message. In the example in FIG. 13, the S-NODE ADDITION REQUEST message optionally includes a new information element, “Flight Path Information List”. The Flight Path Information List IE contains Flight Path Information Items IEs up to a specified maximum number. A Flight Path Information Items IE includes a Waypoint Location IE and optionally a Time Stamp IE. The Waypoint Location IE indicates location coordinates of a planned UE location.

The Time Stamp IE indicates a time stamp per location.

The formats shown in FIGS. 10 through 13 may be modified as appropriate. For example, the names of the information elements or fields shown in FIGS. 10 through 13 are examples, not limitations.

When C-RAN deployment is used, the planned path information may be sent from the source DU of a handover to the target DU via the CU. In this case, the planned path information can be sent from the source DU to the CU and from the CU to the target DU using a HandoverPreparationInformation message similar to that shown in FIG. 10. Alternatively, the planned path information may be sent from the source CU of a handover (via the target CU) to the target DU. In this case, the planned path information can be sent from the source CU to the target DU (via the target CU) using a HandoverPreparationInformation message similar to that shown in FIG. 10. The HandoverPreparationInformation may be contained and transmitted in a DU to CU RRC Information IE from a DU to a CU, or a CU to DU RRC Information IE from a CU to a DU.

### Second Example Embodiment

This example embodiment provides improved inter-RAN node signaling related to dual connectivity. An example configuration of a radio communication system for this example embodiment may be the same as any of the configuration examples described with reference to FIGS. 1, 2, and 4.

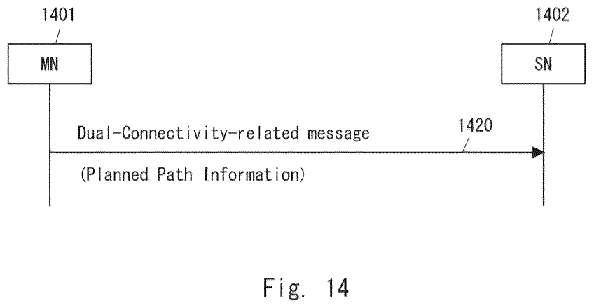

FIG. 14 shows an example of inter-RAN node signaling. In step 1420, an MN 1401 sends planned path information for the UE 3 to an SN 1402. The planned path information may be information reported by the UE 3 to the MN 1401 based on the request of the MN 1401. Prior to step 1420, the MN 1401 may receive the planned path information from the UE 3. The planned path information indicates planned or scheduled locations of the UE. These locations may be 3D locations or 2D locations. In an example, the planned path information may be related to an aerial UE (i.e., UE 3 with aerial UE capabilities) and may be flight path information that includes waypoints defined as 3D locations. In another example, the planned path information may describe planned or scheduled 2D locations of the UE 3 embedded in a land-based vehicle or mobile robot.

The message in step 1420 carrying the planned path information may be sent in a dual connectivity-related procedure. The dual connectivity-related procedure may be an SN addition procedure or a conditional SN addition (or CPA) procedure. This (conditional) SN addition procedure may be performed between the MN and the target SN within an SN change procedure. The message in step 1420 carrying the planned path information may be an S-NODE ADDITION REQUEST message. The planned path information may be contained in an inter-node RRC message. More specifically, the RAN node 1401 may send the planned path information to the RAN node 1402 via an inter-node RRC message in an S-NODE ADDITION REQUEST message. The formats of these may be the same as in the examples described using FIGS. 12 and 13.

The message in step 1420 carrying the planned path information may be any other message related to dual connectivity. For example, the message of step 1420 may be an S-NODE MODIFICATION REQUEST message or an S-NODE MODIFICATION CONFIRM message.

According to the signaling described with reference to FIG. 14, the MN 1401 provides the SN 1402 with planned path information for the UE 3. This allows the SN 1402, for example, to use the planned path information to optimize a (conditional) SN addition for the UE 3 or to optimize an SCG configuration for the UE 3.

The SN 1402 may use the received planned path information for various purposes. For example, the SN 1402 may predict or determine the current or future location(s) of the UE 3 by considering the planned locations of the UE 3 and optionally a time stamp per location. The SN 1402 may consider the location(s) of the UE 3, predicted or determined based on the planned path information, in various decisions regarding dual connectivity for the UE 3. These applications may be similar to those described for dual connectivity in the first example embodiment.

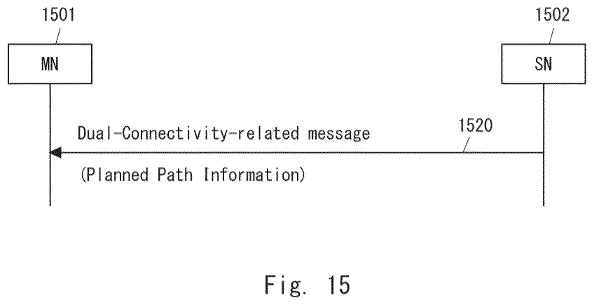

FIG. 15 shows an example of inter-RAN node signaling. In step 1520, an SN 1502 sends planned path information for the UE 3 to an MN 1501. The planned path information may be information reported by the UE 3 to the SN 1502 based on the request of the SN 1502. Prior to step 1520, the SN 1502 may receive the planned path information from the UE 3. The definitions and examples of the planned path information may be similar to those described in relation to FIG. 14.

The message in step 1520 carrying the planned path information may be, for example, an S-NODE MODIFICATION REQUEST ACKNOWLEDGE, S-NODE MODIFICATION REQUIRED, or S-NODE CHANGE REQUIRED message. The planned path information may be included in an inter-node RRC message in these messages. The inter-node RRC message may be, for example, a CG-Config message or a CG-CandidateList message contained in an S-NG-RAN node to M-NG-RAN node Container IE.

According to the signaling described with reference to FIG. 15, the SN 1502 provides the MN 1501 with planned path information for the UE 3 in a dual connectivity-related procedure for the UE 3. This allows the MN 1501, for example, to use the planned path information to optimize dual connectivity for the UE 3, or to optimize an MCG configuration for the UE 3, or to optimize mobility (e. g., handover) of the UE 3.

The MN 1501 may use the received planned path information for various purposes. For example, the MN 1501 may predict or determine the current or future location(s) of the UE 3 by considering the planned locations of the UE 3 and optionally a time stamp per location. The MN 1501 may consider the location(s) of the UE 3, predicted or determined based on the planned path information, in its various decisions regarding mobility and dual connectivity for the UE 3.

For example, the MN 1501 may consider the planned path information or the predicted location(s) of the UE 3 based on the planned path information to determine a target cell for a handover of the UE 3. The handover may be an inter-MN handover, a Master Node to eNB/gNB Change, or an eNB/gNB to Master Node Change.

Additionally or alternatively, the MN 1501 may consider the planned path information or the predicted location(s) of the UE 3 based on the planned path information to determine an SN addition or change for the UE 3. In other words, the MN 1501 may consider the planned path information or the predicted location(s) of the UE 3 based on the planned path information to determine a new PSCell or SN for the UE 3. The SN addition or change may be a conditional SN addition or change.

### Third Example Embodiment

This example embodiment provides improved inter-RAN node signaling related to dual connectivity. An example configuration of a radio communication system for this example embodiment may be the same as any of the configuration examples described with reference to FIGS. 1, 2, and 4.

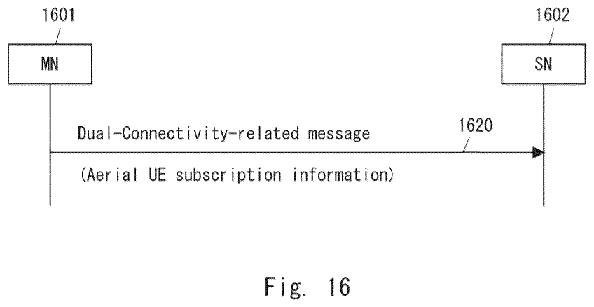

FIG. 16 shows an example of inter-RAN node signalling. In step 1620, an MN 1601 sends aerial UE subscription information regarding a UE 3, or information derived therefrom, to the SN 1602. The aerial UE subscription information regarding the UE 3 may be aerial UE subscription information of the user of the UE 3. The aerial UE subscription information may be information sent from an HSS or Unified Data Management (UDM) in a core network to the MN 1 via a core network node (e.g., MME or Access and Mobility Management Function (AMF)). The aerial UE subscription information may be information sent to the MN 1601 by another RAN node in a previous handover.

The aerial UE subscription information indicates the user's subscription authorisation to operate aerial UEs. The aerial UE subscription information can be used by a RAN node to know if the UE 3 (or its user) is allowed to use the aerial UE functionality. The aerial UE subscription information sent from the MN 1601 to the SN 1602 in step 1620, or information derived therefrom, may indicate whether or not the UE 3 (or its user) is allowed to use the aerial UE functionality. Additionally or alternatively, the information may indicate whether or not the UE 3 is an aerial UE. Additionally or alternatively, the information may indicate whether or not the UE 3 supports aerial UE functionality.

The message in step 1620 carrying the aerial UE subscription information may be a dual connectivity-related message. The MN 1601 may send the aerial UE subscription information to the SN 1602 during an SN addition procedure. This SN addition procedure may be a conditional SN addition procedure. In this case, the message of step 1620 may be an S-NODE ADDITION REQUEST message. Alternatively, the message of step 1620 may be an S-NODE MODIFICATION REQUEST message.

According to the signaling described with reference to FIG. 16 the MN 1601 provides the SN 1602 with the aerial UE subscription information regarding the UE 3. This allows the SN 1602, for example, to use the aerial UE subscription information to determine whether to perform aerial UE-related operations for the UE 3.

The procedure in FIG. 16 may be modified as follows. The MN 1601 may send flight path information indicating a plurality of planned locations of the UE 3 to the SN 1602 together with the aerial UE subscription information or information derived therefrom. The transmission of the flight path information from the MN 1601 to the SN 1602 can be the same as that described in the second example £ embodiment with reference to FIG. 14.

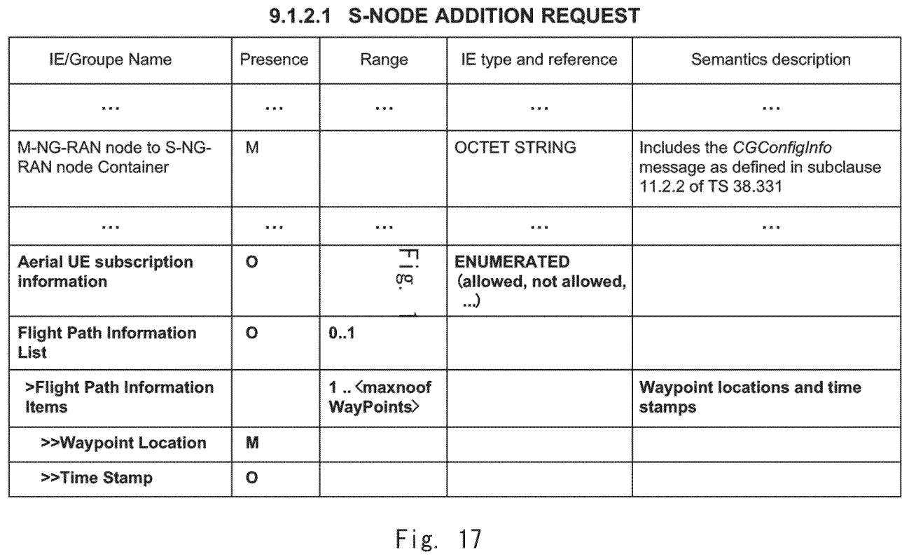

FIG. 17 shows an example of the format of an S-NODE ADDITION REQUEST message. In the example in FIG. 17, the S-NODE ADDITION REQUEST message optionally includes a new information element, “Aerial UE subscription information”. The Aerial UE subscription information IE can be used by the SN to know if the UE 3 or its user is allowed to use aerial UE functions. The Aerial UE subscription information IE is of an enumerated type and may indicate “allowed”or “not allowed”.

In the example in FIG. 17, the S-NODE ADDITION REQUEST message optionally includes a new information element, “Flight Path Information List”. This information element is the same as the one shown in FIG. 13.

### Fourth Example Embodiment

This example embodiment provides an improvement in the operation of RAN nodes with respect to conditional mobility. An example configuration of a radio communication system in this example embodiment may be the same as any of the configuration examples described with reference to FIGS. 1 through 4.

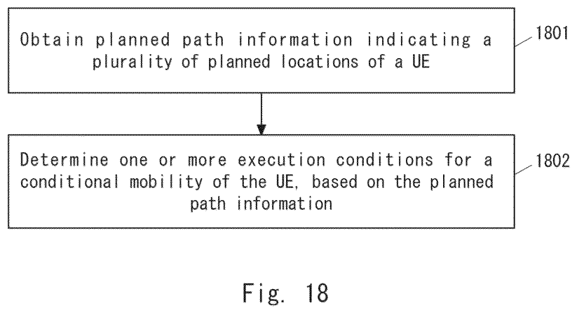

FIG. 18 shows an example operation of a RAN node. The RAN node is a node that determines one or more execution conditions to be provided to the UE 3 for a conditional handover, a conditional SN addition, a conditional SN change (or inter-SN CPC), or a conditional SN modification (or intra-SN CPC). Specifically, the RAN node may be the source RAN node of a conditional handover (e.g., RAN node 6 in FIG. 3), the MN of a conditional SN addition (e.g., MN 1 in FIG. 2), the MN of an MN-initiated conditional SN change (e.g., MN 1 in FIG. 1), the source SN of an SN-initiated conditional SN change (e.g., SN 2 in FIG. 1), or the SN of a conditional SN modification (e.g., SN 2 in FIG. 2).

In step 1801, the RAN node obtains planned path information indicating a plurality of planned locations of the UE 3. The planned path information may be information reported by the UE 3 to the RAN node upon request of the RAN node. The RAN node may read the planned path information that has been stored in a memory or storage. The RAN node may receive the planned path information from another RAN node.

The planned path information indicates planned or scheduled locations of the UE. These locations may be 3D locations or 2D locations. In an example, the planned path information may be related to an aerial UE (i.e., UE 3 with aerial UE capabilities) and may be flight path information that includes waypoints defined as 3D locations. In another example, the planned path information may describe planned or scheduled 2D locations of the UE 3 embedded in a land-based vehicle or mobile robot.

In step 1802, the RAN node determines one or more execution conditions for a conditional mobility of the UE 3 based on the planned path information.

The one or more execution conditions may include a location of the UE being at a reference location, within a configured distance from a reference location, or within a reference area. The RAN node may determine the reference location or the reference area based on the planned location(s) indicated by the planned path information. The RAN node may predict or determine the current or future location(s) of the UE 3 by considering the planned locations of the UE 3 and optionally a time stamp per location. The RAN node may then determine or configure the reference location or the reference area to correspond to the predicted or determined location of the UE 3.

Additionally or alternatively, the one or more execution conditions may include that the distance between the UE 3 and the reference location of the conditional reconfiguration candidate is shorter than a configured threshold value.

Additionally or alternatively, the one or more execution conditions may include reaching a scheduled time. The scheduled time may be associated with a future location of the UE 3 as predicted based on the planned path information.

According to the operation described in this example embodiment, the RAN node can determine execution conditions for conditional mobility of the UE 3 based on the planned path information of the UE 3. This can contribute to improved conditional mobility suitable for the UE 3 (e.g., aerial UE) moving according to the planned path information.

### Fifth Example Embodiment

This example embodiment provides improved handover and conditional handover. An example configuration of a radio communication system in this example embodiment may be the same as any of the configuration examples described with reference to FIG. 3 and FIG. 4.

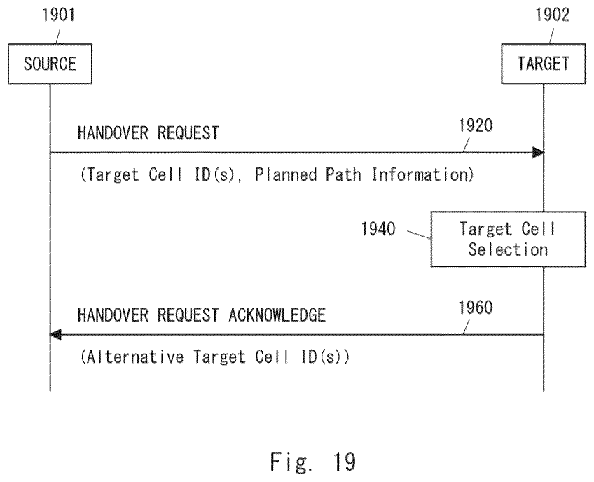

FIG. 19 shows an example of a signalling procedure for a handover of the UE 3. The handover may be a conditional handover. In step 1920, a source RAN node 1901 sends a handover request to a target RAN node 1902. Specifically, the source RAN node 1901 sends a HANDOVER REQUEST message to the target RAN node 1902. The HANDOVER REQUEST message requests the handover of the UE 3 and specifies one or more target cells. The HANDOVER REQUEST message further contains planned path information indicating a plurality of planned locations of the UE 3. The planned path information may be information reported by the UE 3 to the source RAN node 1901 upon request of the source RAN node 1901. The planned path information indicates planned or scheduled locations of the UE. These locations may be 3D locations or 2D locations. In an example, the planned path information may be related to an aerial UE (i.e., UE 3 with aerial UE capabilities) and may be flight path information that includes waypoints defined as 3D locations. In another example, the planned path information may describe planned or scheduled 2D locations of the UE 3 embedded in a land-based vehicle or mobile robot.

In step 1940, the target RAN node 1902 selects a target cell. Specifically, the target RAN node 1902 may determine whether or not the handover request to the one or more target cells specified by the HANDOVER REQUEST message is acceptable. If the handover request to the target cell(s) specified in the HANDOVER REQUEST message is not acceptable, the target RAN node 1902 may select another cell different from the target cell(s) specified in the HANDOVER REQUEST message as an alternative target cell. Alternatively, if there is a cell more suitable for serving the UE 3 than the one or more target cells specified by the HANDOVER REQUEST message, the target RAN node 1902 may select such a cell as an alternative or additional target cell.

The target RAN node 1902 may select or determine an alternative or additional target cell based on, using, or considering the planned path information of the UE 3. For example, the target RAN node 1902 may predict or determine the current or future location(s) of the UE 3 by considering the planned locations of the UE 3 and optionally a time stamp per location. The target RAN node 1902 may select at least one cell covering or surrounding the predicted or determined location of the UE 3 as an alternative or additional target cell.

The target RAN node 1902 may select or determine an alternative or additional target cell, at least provided that the HANDOVER REQUEST message contains the planned path information. In other words, if the HANDOVER REQUEST message contains the planned path information, then the target RAN node 1902 may select or determine an alternative or additional target cell.

In step 1960, the target RAN node 1902 sends a handover request response to the source RAN node 1901. Specifically, the target RAN node 1902 sends a HANDOVER REQUEST ACKNOWLEDGE message to the source RAN node 1901. The HANDOVER REQUEST ACKNOWLEDGE message indicates one or more alternative or additional target cells that are acceptable for the handover of the UE 3. The HANDOVER REQUEST ACKNOWLEDGE message may indicate the identifier(s) of the alternative or additional target cell(s).

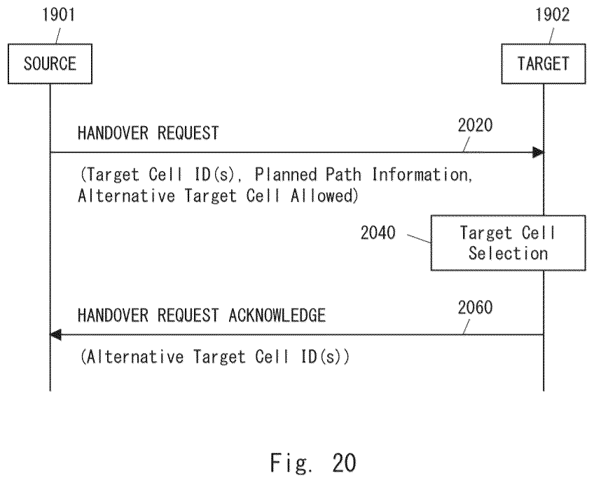

FIG. 20 shows a modification of the signaling procedure described using FIG. 19. In the example in FIG. 20, the HANDOVER REQUEST message in step 2020 includes an explicit indication that an alternative cell proposal is allowed. The name of this indication may be, for example, but not limited to, an “Alternative Target Cell Allowed” information element. Steps 2020 and 2060 are similar to steps 1940 and 1960 in FIG. 19. However, in step 2040, the target RAN node 1902 selects or determines an alternative or additional target cell, provided that the HANDOVER REQUEST message contains the above indication that the proposed alternative cell is allowed.

According to the handover procedure described with reference to FIGS. 19 and 20, the target RAN node 1902 can propose an alternative or additional target cell only under certain circumstances or conditions where it is useful to do so.

### Another Example Embodiment 1

At each location specified in the planned path information, the UE 3 may perform a measurement specified by the network (RAN node) and store measurement results and the location information of the UE 3 as a log. Alternatively, at each location specified in the planned path information, the UE 3 may store measurement results and the location information of the UE 3 that it has at that time as a log. The UE 3 may report the stored log to the network. These may be Immediate Minimization of Drive Test (MDT) or Logged MDT. In the case of Immediate MDT, they may be reported via a measurement report procedure. For example, upon reaching (or staying at) each location specified in the planned path information, the UE 3 may report to the network the measurement results it has at that time and the location of the UE 3.

### Another Example Embodiment 2

A RAN node may perform a beam management associated with altitude. Specifically, the RAN node may associate a configuration regarding a beam or beam control with an altitude/height. For example, if the UE 3 is an aerial UE, the RAN node may pre-configure the UE 3 with altitude-specific beam or beam control configurations. The UE 3 may select a beam or beam control configuration according to its altitude. The beam control configuration may be a Transmission Configuration Indicator (TCI) state IE, a MeasConfig IE, a BeamFailureRecovery Config IE, a BeamFailureRecovery ServingCellConfig IE, or any combination of these. In addition, the TCI state IE may be related to Multiple Transmission and Reception Point (mTRP) operation. For example, based on planned path information, the RAN node may preconfigure the UE 3 with altitude-specific beam or beam control configurations, each corresponding to one of the TRPs associated with multiple cells. The UE 3 may select a beam or beam control configuration according to its altitude. In the example embodiments described above, any RAN node in a mobility-related procedure or dual connectivity-related procedure may perform these operations.

### Another Example Embodiment 3

A RAN node may perform a beam management associated with a waypoint. Specifically, the RAN node may associate a configuration regarding a beam or beam control with a waypoint. For example, if the UE 3 is an aerial UE, the RAN node may pre-configure the UE 3 with waypoint-specific beam or beam control configurations. The UE 3 may select a beam or beam control configuration according to its 3D position. The beam control configuration may be a TCI state IE, a MeasConfig IE, a BeamFailureRecovery Config IE, a BeamFailureRecovery ServingCellConfig IE, or any combination of these. In addition, the TCI state IE may be related to mTRP operation. For example, based on planned path information, the RAN node may preconfigure the UE 3 with waypoint-specific beam or beam control configurations, each corresponding to one of the TRPs associated with multiple cells. The UE 3 may select a beam or beam control configuration according to its 3D position. In the example embodiments described above, any RAN node in a mobility-related procedure or dual connectivity-related procedure may perform these operations.

### Another Example Embodiment 4

During a mobility-related procedure, the UE 3 may detect a radio link failure (e.g., Radio Link Failure (RLF)), for example, due to a degradation of the radio quality (e.g., Reference Signal Received Power (RSRP), Reference Signal Received Quality (RSRQ)) of the serving cell, which may cause the UE 3 to fail the mobility-related procedure. In this case, the UE 3 tries to reconnect the radio link (e. g., RRC (connection) re-establishment), for example, in a cell with the best radio quality or with a higher priority. If the UE 3 is an aerial UE, it is preferable that the cell to be reconnected (i.e., the RAN node managing that cell) supports aerial UEs. In this situation, the RAN node may share aerial UE support information with other RAN nodes managing cells in the vicinity (e. g., neighboring cells) of the serving cell. The aerial UE support information may indicate support in the respective cell (e.g., Served Cell) or in the RAN node. These may be sent, for example, in Xn Setup Request and Xn Setup Response messages.

The RAN node may send information to the UE 3 about the support of aerial UEs in neighboring cells. Additionally or alternatively, the RAN Node may send information to the UE 3 about the support of aerial UEs in neighboring frequencies (i.e., frequencies other than that of the serving cell). The UE 3 may take the information about the support of aerial UEs into account when deciding which cell to reconnect. For example, if the reconnection occurs while the UE 3 is performing aerial functions, the UE 3 may preferentially select a cell (or frequency) that supports aerial UEs. Alternatively, the UE 3 may preferentially select a cell (or frequency) that supports aerial UEs, regardless of whether or not it was performing aerial functions when the reconnection occurred or before the reconnection. The information about the support of aerial UEs may be sent in broadcast information (e.g., any System Information Block (SIB), SIBx) or in dedicated signaling (e.g., RRC messages).

In addition, the UE 3 may use the information about the support of aerial UEs in a mobility (e.g., cell reselection) in the RRC_IDLE or RRC INACTIVE state. For example, the UE 3 may take into account the information about the support of aerial UEs when selecting a target cell for cell reselection, in a manner similar to the case of reconnection. Specifically, the UE 3 may preferentially reselect a cell (or frequency) that supports aerial UEs. The aerial UE support information and the information about support of aerial UEs may be aerial function support information and information about support of aerial functions, or equivalent information, respectively.

The RAN node may be a CU (e.g., gNB-CU) or a combination of a CU and one or more DUs (e. g., eNB-DUs or gNB-DUs) in a C-RAN deployment. If the RAN node is a combination of a CU and one or more DUs, the aerial UE support information may be sent from the CU to one or more DUs or from each of the one or more DUs to the CU. In the latter case, the CU may send (or forward) the aerial UE support information received from one DU to one or more other DUs. On the other hand, the information about support of aerial UE may be sent from the CU to the UE (via a DU) or from a DU to the UE (once via a CU).

### Another Example Embodiment 5

When a target RAN node sends configuration information to the UE 3 about a target cell (e.g., target cell for handover, target PSCell for dual connectivity) in a mobility-related procedure, it may send information about future candidate cells associated with the planned path information to the UE 3. For example, the information about future candidate cells associated with the planned path information may include information about a recommended cell for each of the one or more waypoints included in the planned path information (e.g., information indicating the correspondence between waypoints and cells, or a list of such information). The information about recommended cells may include only cells managed by the target RAN node itself, or it may include information about cells managed by other RAN nodes owned by the target RAN node. If the UE 3 needs to reconnect its radio link (e.g., RRC (connection) re-establishment) while performing a mobility-related procedure or while staying in a serving cell (e.g., source or target cell), it can use this information to determine which cell to try to reconnect to. For example, the UE 3 may check the waypoint closest to its location at the time of the reconnection attempt and preferentially select the recommended cell for that waypoint, or it may increase the priority of that cell in the cell selection. This allows the UE 3 to properly select the cell to which it will attempt to reconnect.

Additionally or alternatively, when the RAN node sends an RRC message (e.g., RRC (Connection) Release) releasing the radio connection (e.g., RRC Connection) to transition the UE 3 to the RRC IDLE or RRC INACTIVE state, it may send the information about future candidate cells associated with the planned path information.

The UE 3 may then use this information in a mobility (e.g., cell reselection) in the RRC_IDLE or RRC_INACTIVE state.

### Another Example Embodiment 6

As described above, during a mobility-related procedure or while staying in a serving cell, the UE 3 may detect a radio link disconnection (e.g., RLF), for example due to degradation of the radio quality (e.g., RSRP, RSRQ) of the serving cell. In addition, the UE 3 may fail in its attempts to reconnect the radio link. In such cases, the UE 3 may need to perform emergency operations. For example, if the UE 3 is an aerial UE and its movement is controlled by radio communication with a RAN node, the UE 3 may need to perform an emergency landing in response to the loss of the radio communication.

Accordingly, information about emergency landing points associated with the planned path information may be transmitted to the UE 3 in advance. The emergency landing point information associated with the planned path information may indicate or include location information of a point where an emergency landing is permitted or recommended for each of the one or more waypoints. Alternatively, the emergency landing point information associated with the planned path information may be location information of one or more points in the serving cell or in the location registration area (e.g., Tracking Area (TA)) of the UE 3, or associated with the serving cell or the location registration area, where an emergency landing is permitted or recommended. If the emergency landing point information indicates a point within or associated with the serving cell, the RAN node serving the serving cell may transmit this in advance to the UE 3 in advance, for example in an RRC message, while the UE 3 is in the serving cell. On the other hand, if the emergency landing point information indicates a point within or associated with the location registration area of the UE 3, the core network node (e. g., AMF or MME) may transmit this in advance to the UE 3 during a location (re-)registration procedure (e.g., TA update) of the UE 3.

For example, if the UE 3 fails to re-establish the radio link, for example, it may initiate an emergency landing operation and determine the target point for an emergency landing attempt based on the emergency landing point information. This allows the UE 3 to perform an emergency landing quickly and safely if it detects a radio link disconnection (e.g., RLF) during a mobility-related procedure or while in a serving cell.

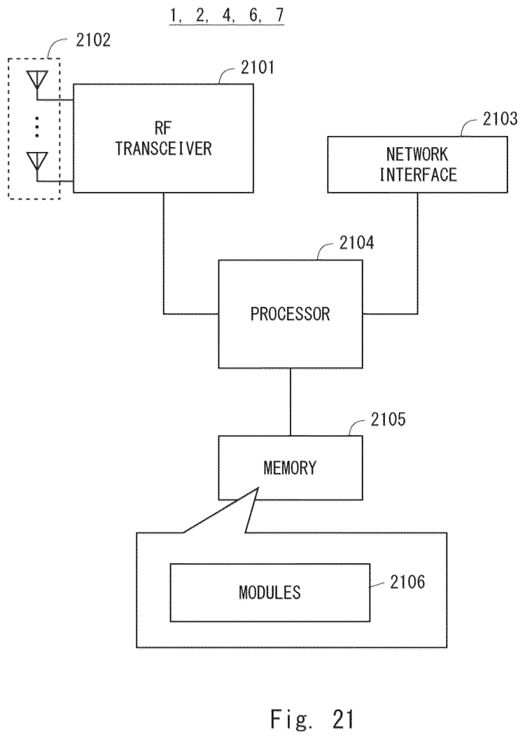

Examples of configurations of the RAN nodes 1, 2, 4, 6, and 7 and the UE 3 according to the plurality of example embodiments described above are provided below. FIG. 21 is a block diagram showing an example of the configuration of the RAN node 1. The configuration of the RAN nodes 2, 4, 6, and 7 may be the same as the configuration shown in FIG. 21. In addition, the configuration of the other RAN nodes described in the example embodiments above (e.g., RAN nodes 501, 502, 1401, 1402, 1501, 1502, 1601, 1602, 1901, and 1902) may be the same as the configuration shown in FIG. 21.

Referring to FIG. 21, the RAN node 2 includes a Radio Frequency (RF) transceiver 2101, a network interface 2103, a processor 2104, and a memory 2105. The RF transceiver 2101 performs analog RF signal processing to communicate with UEs including the UE 3. The RF transceiver 2101 may include a plurality of transceivers. The RF transceiver 2101 is coupled to an antenna array 2102 and the processor 2104. The RF transceiver 2101 receives modulated symbol data from the processor 2104, generates a transmission RF signal, and supplies the transmission RF signal to the antenna array 2102. The RF transceiver 2101 generates a baseband reception signal based on a reception RF signal received by the antenna array 2102 and supplies the baseband reception signal to the processor 2104. The RF transceiver 2101 may include an analog beamformer circuit for beamforming. The analog beamformer circuit includes, for example, a plurality of phase shifters and a plurality of power amplifiers.

The network interface 2103 is used to communicate with network nodes (e.g., RAN nodes 2 and 4, and control and forwarding nodes in the core network). For example, the network interface 2103 may include a network interface card (NIC) that complies with the IEEE 802.3 series.

The processor 2104 performs digital baseband signal processing (data plane processing) and control plane processing for wireless communication. The processor 2104 may include a plurality of processors. For example, the processor 2104 may include a modem processor (e.g., a Digital Signal Processor (DSP)) that performs digital baseband signal processing and a protocol stack processor (e.g., a Central Processing Unit (CPU) or a Micro Processing Unit (MPU)) that performs control plane processing.

For example, the digital baseband signal processing performed by the processor 2104 may include signal processing for the Service Data Adaptation Protocol (SDAP), Packet Data Convergence Protocol (PDCP), Radio Link Control (RLC), Medium Access Control (MAC), and Physical (PHY) layers. The control plane processing by the processor 2104 may also include processing of Non-Access Stratum (NAS) messages, RRC messages, MAC Control Elements (CEs), and Downlink Control Information (DCI).

The processor 2104 may include a digital beamformer module for beamforming. The digital beamformer module may include a multiple input multiple output (MIMO) encoder and precoder.

The memory 2105 is composed of a combination of volatile and non-volatile memory. The volatile memory is, for example, Static Random Access Memory (SRAM), Dynamic RAM (DRAM), or a combination thereof. The non-volatile memory is Mask Read Only Memory (MROM), Electrically Erasable Programmable ROM (EEPROM), flash memory, hard disk drive, or any combination thereof. The memory 2105 may include storage that is remote from the processor 2104. In this case, the processor 2104 may access the memory 2105 through the network interface 2103 or an I/O interface not shown.

The memory 2105 may store one or more software modules (or computer programs) 2106 containing a set of instructions and data for processing by the RAN node 1 described in the example embodiments described above. In some implementations, the processor 2104 may be configured to read and execute the software module 2106 from the memory 2105, thereby performing the processing of the RAN node 1 described in the example embodiments described above.

If the RAN Node 1 is a CU (e.g., eNB-CU or gNB-CU) or a CU-CP, the RAN Node 1 does not need to include the RF transceiver 2101 (and the antenna array 2102).

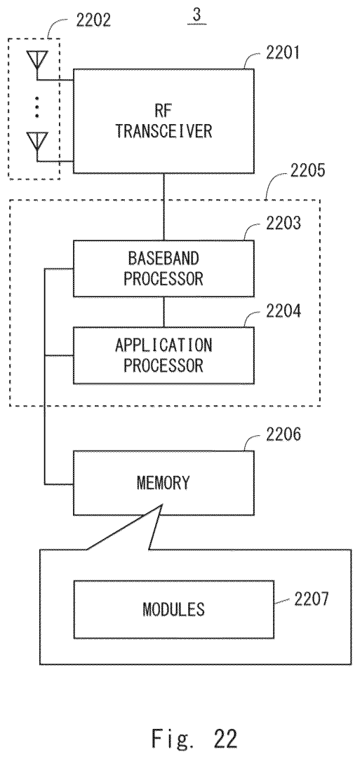

FIG. 22 shows a block diagram of an example configuration of the UE 3. The Radio Frequency (RF) transceiver 2201 performs analog RF signal processing to communicate with RAN nodes. The RF transceiver 2201 may include a plurality of transceivers. The analog RF signal processing performed by the RF transceiver 2201 includes frequency up-conversion, frequency down-conversion, and amplification. The RF transceiver 2201 is coupled with an antenna array 2202 and a baseband processor 2203. The RF transceiver 2201 receives modulated symbol data (or OFDM symbol data) from the baseband processor 2203, generates a transmission RF signal, and supplies the transmission RF signal to the antenna array 2202. The RF transceiver 2201 also generates a baseband received signal based on a received RF signal received by the antenna array 2202, and supplies the baseband received signal to the baseband processor 2203. The RF transceiver 2201 may include an analog beamformer circuit for beamforming. The analog beamformer circuit includes, for example, multiple phase shifters and multiple power amplifiers.

The baseband processor 2203 performs digital baseband signal processing (data-plane processing) and control-plane processing for wireless communication. The digital baseband signal processing includes (a) data compression/decompression, (b) data segmentation/concatenation, (c) transmission format (transmission frame) composition/decomposition, (d) channel encoding/decoding, (e) modulation (i.e., symbol mapping)/demodulation, and (f) generation of OFDM symbol data (baseband OFDM signal) using Inverse Fast Fourier Transform (IFFT) and so on. On the other hand, the control-plane processing includes communication management of layer 1 (e. g., transmission power control), layer 2 (e. g., radio resource management, and hybrid automatic repeat request (HARQ) processing), and layer 3 (e. g., signaling related to attach, mobility, and call management).

For example, the digital baseband signal processing performed by the baseband processor 2203 may include signal processing for the SDAP, PDCP, RLC, MAC, and PHY layers. The control plane processing by the baseband processor 2203 may include processing of Non-Access Stratum (NAS) protocols, RRC protocols, MAC CEs, and DCIs.

The baseband processor 2203 may perform MIMO encoding and precoding for beamforming.

The baseband processor 2203 may include a modem processor (e.g., DSP) that performs digital baseband signal processing and a protocol stack processor (e.g., CPU or MPU) that performs control plane processing. In this case, the protocol stack processor that performs control plane processing may be integrated with an application processor 2204 described later.

The application processor 2204 is also referred to as a CPU, MPU, microprocessor, or processor core. The application processor 2204 may include a plurality of processors (a plurality of processor cores). The application processor 2204 executes system software programs (operating system (OS)) and various application programs (e. g., voice call application, web browser, mailer, camera control application, music player application) read from a memory 2206 or other memory not shown, thereby realizing various functions of the UE 3.

In some implementations, as shown by the dashed line (2205) in FIG. 22, the baseband processor 2203 and the application processor 2204 may be integrated on a single chip. In other words, the baseband processor 2203 and the application processor 2204 may be implemented as a single System on Chip (SoC) device 2205. The SoC device may also be referred to as a system large-scale integration (LSI) or chipset.

The memory 2206 is a volatile memory, a non-volatile memory, or a combination thereof. The memory 2206 may include a plurality of physically independent memory devices. The volatile memory is, for example, SRAM, DRAM, or a combination thereof. The non-volatile memory is, for example, MROM, EEPROM, flash memory, or a hard disk drive, or any combination thereof. For example, the memory 2206 may include an external memory device that is accessible by the baseband processor 2203, the application processor 2204, and the SoC 2205. The memory 2206 may include an internal memory device that is integrated into the baseband processor 2203, the application processor 2204, or the SoC 2205. In addition, the memory 2206 may include memory within a Universal Integrated Circuit Card (UICC).

The memory 2206 may store one or more software modules (or computer programs) 2207 that include a set of instructions and data for performing the processing by the radio terminal 3 described in the above example embodiments. In some implementations, the baseband processor 2203 or the application processor 2204 may be configured to read and execute the software modules 2207 from the memory 2206, thereby performing the processing of the UE 3 as described in the example embodiments with reference to the drawings.

The control plane processing and operations performed by the UE 3 described in the above example embodiment can be implemented by elements other than the RF transceiver 2201 and the antenna array 2202, namely at least one of the baseband processor 2203 and the application processor 2204, and the memory 2206 that stores the

As described using FIGS. 21 and 22, each of the processors in the RAN nodes and UE according to the example embodiments described above can execute one or more programs, containing a set of instructions, to cause a computer to perform an algorithm described with reference to the drawings. Each of these programs contains a set of instructions (or software codes) that, when loaded into a computer, causes the computer to perform one or more of the functions described in the example embodiments. Each of these programs may be stored in a non-transitory computer readable medium or a tangible storage medium. By way of example, and not limitation, non-transitory computer readable media or tangible storage media can include a random-access memory (RAM), a read-only memory (ROM), a flash memory, a solid-state drive (SSD) or other memory technologies, CD-ROM, digital versatile disk (DVD), Blu-ray (registered trademark) disc or other optical disk storage, magnetic cassettes, magnetic tape, magnetic disk storage or other magnetic storage devices. Each program may be transmitted on a transitory computer readable medium or a communication medium. By way of example, and not limitation, transitory computer readable media or communication media can include electrical, optical, acoustic, or other form of propagated signals.

The example embodiments described above are merely examples of applications of the technical ideas of the inventors. These technical ideas are not limited to the above-described example embodiments, and various modifications may be made thereto.

For example, the whole or part of the example embodiments disclosed above can be described as, but not limited to, the following supplementary notes.

### Supplementary Note 1

A first radio access network (RAN) node comprising:
at least one memory; and
at least one processor coupled to the at least one memory and configured to send to a second RAN node, in a mobility-related procedure or a dual connectivity-related procedure with respect to a User Equipment (UE), planned path information indicating a plurality of planned locations of the UE.

### Supplementary Note 2

The first RAN node according to Supplementary Note 1, wherein the planned path information is flight path information indicating a plurality of waypoints defined as three-dimensional locations.

### Supplementary Note 3

The first RAN node according to Supplementary Note 1 or 2, wherein the UE is a UE with aerial UE functionality.

### Supplementary Note 4

The first RAN node according to any one of Supplementary Notes 1 to 3, wherein
the at least one processor is configured to send the planned path information to the second RAN node in the mobility-related procedure, and
the mobility-related procedure is a handover procedure or a conditional handover procedure.

### Supplementary Note 5

The first RAN node according to any one of Supplementary Notes 1 to 3, wherein
the at least one processor is configured to send the planned path information to the second RAN node in the dual connectivity-related procedure, and
the dual connectivity-related procedure is a secondary node (SN) addition procedure, a conditional SN addition procedure, an SN change procedure, or a conditional SN change procedure.

### Supplementary Note 6

The first RAN node according to Supplementary Note 5, wherein the first RAN node and the second RAN node are respectively a master node (MN) and a SN in the SN addition procedure or the conditional SN addition procedure, an MN and a target SN in the SN change procedure or the conditional SN change procedure, or a source SN and an MN in the SN change procedure or the conditional SN change procedure.

### Supplementary Note 7

The first RAN node according to any one of Supplementary Notes 1 to 3, wherein the at least one processor is configured to send the planned path information to the second RAN node in a conditional handover procedure, a conditional secondary node (SN) addition procedure, or a conditional SN change procedure.

### Supplementary Note 8

The first RAN node according to any one of Supplementary Notes 1 to 7, wherein the at least one processor is configured to send the planned path information to the second RAN node via a HANDOVER REQUEST message, an S-NODE ADDITION REQUEST message, or an S-NODE CHANGE REQUIRED message.

### Supplementary Note 9

The first RAN node according to any one of Supplementary Notes 1 to 7, wherein the at least one processor is configured to send the planned path information to the second RAN node via an inter-node Radio Resource Control (RRC) message.

### Supplementary Note 10

The first RAN node according to any one of Supplementary Notes 1 to 9, wherein the planned path information is used by the second RAN node to determine whether to accept a handover of the UE to a target cell or a secondary node (SN) addition or change for the UE.

### Supplementary Note 11

The first RAN node according to any one of Supplementary Notes 1 to 9, wherein the planned path information is used by the second RAN node to determine at least one acceptable cell among one or more target or candidate cells.

### Supplementary Note 12

The first RAN node according to any one of Supplementary Notes 1 to 9, wherein the planned path information is used by the second RAN node to generate or prepare a configuration of a target or candidate cell.

### Supplementary Note 13

The first RAN node according to any one of Supplementary Notes 1 to 9, wherein the planned path information is used by the second RAN node to select a secondary cell for carrier aggregation.

### Supplementary Note 14

A method performed by a first radio access network (RAN) node, the method comprising:
sending to a second RAN node, in a mobility-related procedure or a dual connectivity-related procedure with respect to a User Equipment (UE), planned path information indicating a plurality of planned locations of the UE.

### Supplementary Note 15

A program for causing a computer to perform a method for a first radio access network (RAN) node, the method comprising:
sending to a second RAN node, in a mobility-related procedure or a dual connectivity-related procedure with respect to a User Equipment (UE), planned path information indicating a plurality of planned locations of the UE.

### Supplementary Note 16

A second radio access network (RAN) node comprising:
at least one memory; and
at least one processor coupled to the at least one memory and configured to receive from a first RAN node, in a mobility-related procedure or a dual connectivity-related procedure with respect to a User Equipment (UE), planned path information indicating a plurality of planned locations of the UE.

### Supplementary Note 17

The second RAN node according to Supplementary Note 16, wherein the planned path information is flight path information indicating a plurality of waypoints defined as three-dimensional locations.

### Supplementary Note 18

The second RAN node according to Supplementary Note 16 or 17, wherein the UE is a UE with aerial UE functionality.

### Supplementary Note 19

The second RAN node according to any one of Supplementary Notes 16 to 18, wherein
the at least one processor is configured to receive the planned path information from the first RAN node in the mobility-related procedure, and
the mobility-related procedure is a handover procedure or a conditional handover procedure.

### Supplementary Note 20

The second RAN node according to any one of Supplementary Notes 16 to 18, wherein
the at least one processor is configured to receive the planned path information from the first RAN node in the dual connectivity related procedure, and
the dual connectivity-related procedure is a secondary node addition, a conditional secondary node addition, a secondary node change, or a conditional secondary node change.

### Supplementary Note 21

The second RAN node according to Supplementary Note 20, wherein the first RAN node and the second RAN node are respectively a master node (MN) and a SN in the SN addition procedure or the conditional SN addition procedure, an MN and a target SN in the SN change procedure or the conditional SN change procedure, or a source SN and an MN in the SN change procedure or the conditional SN change procedure.

### Supplementary Note 22

The second RAN node according to any one of Supplementary Notes 16 to 18, wherein the at least one processor is configured to receive the planned path information from the first RAN node in a conditional handover procedure, a conditional secondary node (SN) addition procedure, or a conditional SN change procedure.

### Supplementary Note 23

The second RAN node according to any one of Supplementary Notes 16 to 22, wherein the at least one processor is configured to receive the planned path information from the first RAN node via a HANDOVER REQUEST message, an S-NODE ADDITION REQUEST message, or an S-NODE CHANGE REQUIRED message.

### Supplementary Note 24

The second RAN node according to any one of Supplementary Notes 16 to 22, wherein the at least one processor is configured to receive the planned path information from the first RAN node via an inter-node Radio Resource Control (RRC) message.

### Supplementary Note 25

The second RAN node according to any one of Supplementary Notes 16 to 24, wherein the at least one processor is configured to use the planned path information to determine whether to accept a handover of the UE to a target cell or a secondary node (SN) addition or change for the UE.

### Supplementary Note 26

The second RAN node according to any one of Supplementary Notes 16 to 24, wherein the at least one processor is configured to use the planned path information to determine at least one acceptable cell among one or more target or candidate cells.

### Supplementary Note 27

The second RAN node according to any one of Supplementary Notes 16 to 24, wherein the at least one processor is configured to use the planned path information to generate or prepare a configuration of a target or candidate cell.

### Supplementary Note 28

The second RAN node according to any one of Supplementary Notes 16 to 24, wherein the at least one processor is configured to use the planned path information to select a secondary cell for carrier aggregation.

### Supplementary Note 29

A method performed by a second radio access network (RAN) node, the method comprising:
receiving from a first RAN node, in a mobility-related procedure or a dual connectivity-related procedure with respect to a User Equipment (UE), planned path information indicating a plurality of planned locations of the UE.

### Supplementary Note 30

A program for causing a computer to perform a method for a second radio access network (RAN) node, the method comprising:
receiving from a first RAN node, in a mobility-related procedure or a dual connectivity-related procedure with respect to a User Equipment (UE), planned path information indicating a plurality of planned locations of the UE.

### Supplementary Note 31

A radio access network (RAN) node configured to operate as a master node (MN) in dual connectivity for a User Equipment (UE), the RAN node comprising:
at least one memory; and
at least one processor coupled to the at least one memory and configured to send planned path information indicating a plurality of planned locations of the UE to a secondary node (SN) of the dual connectivity.

### Supplementary Note 32

The RAN node according to Supplementary Note 31, wherein the planned path information is flight path information indicating a plurality of waypoints defined as three-dimensional locations.

### Supplementary Note 33

The RAN node according to Supplementary Note 31 or 32, wherein the UE is a UE with aerial UE functionality.

### Supplementary Note 34

The RAN node according to any one of Supplementary Notes 31 to 33, wherein the UE is a UE implemented in an unmanned or uncrewed aerial vehicle (UAV).

### Supplementary Note 35

The RAN node according to any one of Supplementary Notes 32 to 34, wherein
the at least one processor is configured to send aerial UE subscription information or information derived therefrom to the SN together with the planned path information, and
the aerial UE subscription information or the information derived therefrom indicates whether the UE or a user thereof is allowed to use aerial UE functionality, whether the UE is an aerial UE or not, or whether the UE supports aerial UE functionality or not.

### Supplementary Note 36

The RAN node according to any one of Supplementary Notes 31 to 35, wherein the at least one processor is configured to send the planned path information to the SN in an SN addition procedure.

### Supplementary Note 37

The RAN node according to any one of Supplementary Notes 31 to 36, wherein the at least one processor is configured to send the planned path information to the SN via an S-NODE ADDITION REQUEST message.

### Supplementary Note 38

The RAN node according to any one of Supplementary Notes 31 to 36, wherein the at least one processor is configured to send the planned path information to the SN via an inter-node Radio Resource Control (RRC) message.

### Supplementary Note 39

A method performed by a radio access network (RAN) node configured to operate as a master node (MN) in dual connectivity for a User Equipment (UE), the method comprising:
sending planned path information indicating a plurality of planned locations of the UE to a secondary node (SN) of the dual connectivity.

### Supplementary Note 40

A program for causing a computer to perform a method for a radio access network (RAN) node configured to operate as a master node (MN) in dual connectivity for a User Equipment (UE), the method comprising:
sending planned path information indicating a plurality of planned locations of the UE to a secondary node (SN) of the dual connectivity.

### Supplementary Note 41

A radio access network (RAN) node configured to operate as a secondary node (SN) in dual connectivity for a User Equipment (UE), the RAN node comprising:
at least one memory; and
at least one processor coupled to the at least one memory and configured to receive planned path information indicating a plurality of planned locations of the UE from a master node (MN) of the dual connectivity.

### Supplementary Note 42

The RAN node according to Supplementary Note 41, wherein the planned path information is flight path information indicating a plurality of waypoints defined as three-dimensional locations.

### Supplementary Note 43

The RAN node according to Supplementary Note 41 or 42, wherein the UE is a UE with aerial UE functionality.

### Supplementary Note 44

The RAN node according to any one of Supplementary Notes 41 to 43, wherein the UE is a UE implemented in an unmanned or uncrewed aerial vehicle (UAV).

### Supplementary Note 45

The RAN node according to any one of Supplementary Notes 42 to 44, wherein
the at least one processor is configured to receive aerial UE subscription information or information derived therefrom from the MN together with the planned path information, and
the aerial UE subscription information or the information derived therefrom indicates whether the UE or a user thereof is allowed to use aerial UE functionality, whether the UE is an aerial UE or not, or whether the UE supports aerial UE functionality or not.

### Supplementary Note 46

The RAN node according to any one of Supplementary Notes 41 to 45, wherein the at least one processor is configured to receive the planned path information from the MN in an SN addition procedure.

### Supplementary Note 47

The RAN node according to any one of Supplementary Notes 41 to 46, wherein the at least one processor is configured to receive the planned path information from the MN via an S-NODE ADDITION REQUEST message.

### Supplementary Note 48

The RAN node according to any one of Supplementary Notes 41 to 46, wherein the at least one processor is configured to receive the planned path information from the MN via an inter-node Radio Resource Control (RRC) message.

### Supplementary Note 49

A method performed by a radio access network (RAN) node configured to operate as a secondary node (SN) in dual connectivity for a User Equipment (UE), the method comprising:
receiving planned path information indicating a plurality of planned locations of the UE from a master node (MN) of the dual connectivity.

### Supplementary Note 50

A program for causing a computer to perform a method for a radio access network (RAN) node configured to operate as a secondary node (SN) in dual connectivity for a User Equipment (UE), the method comprising:
receiving planned path information indicating a plurality of planned locations of the UE from a master node (MN) of the dual connectivity.

### Supplementary Note 51

A radio access network (RAN) node configured to operate as a master node (MN) in dual connectivity for a User Equipment (UE), the RAN node comprising:
at least one memory; and
at least one processor coupled to the at least one memory and configured to receive planned path information indicating a plurality of planned locations of the UE from a secondary node (SN) of the dual connectivity.

### Supplementary Note 52

The RAN node according to Supplementary Note 51, wherein the planned path information is flight path information indicating a plurality of waypoints defined as three-dimensional locations.

### Supplementary Note 53

The RAN node according to Supplementary Note 51 or 52, wherein the UE is a UE with aerial UE functionality.

### Supplementary Note 54

A method performed by a radio access network (RAN) node configured to operate as a master node (MN) in dual connectivity for a User Equipment (UE), the method comprising:
receiving planned path information indicating a plurality of planned locations of the UE from a secondary node (SN) of the dual connectivity.

### Supplementary Note 55

A program for causing a computer to perform a method for a radio access network (RAN) node configured to operate as a master node (MN) in dual connectivity for a User Equipment (UE), the method comprising:
receiving planned path information indicating a plurality of planned locations of the UE from a secondary node (SN) of the dual connectivity.

### Supplementary Note 56

A radio access network (RAN) node configured to operate as a secondary node (SN) in dual connectivity for a User Equipment (UE), the RAN node comprising:
at least one memory; and
at least one processor coupled to the at least one memory and configured to send planned path information indicating a plurality of planned locations of the UE to a master node (MN) of the dual connectivity.

### Supplementary Note 57

The RAN node according to Supplementary Note 56, wherein the planned path information is flight path information indicating a plurality of waypoints defined as three-dimensional locations.

### Supplementary Note 58

The RAN node according to Supplementary Note 56 or 57, wherein the UE is a UE with aerial UE functionality.

### Supplementary Note 59

A method performed by a radio access network (RAN) node configured to operate as a secondary node (SN) in dual connectivity for a User Equipment (UE), the method comprising:
sending planned path information indicating a plurality of planned locations of the UE to a master node (MN) of the dual connectivity.

### Supplementary Note 60

A program for causing a computer to perform a method for a radio access network (RAN) node configured to operate as a secondary node (SN) in dual connectivity for a User Equipment (UE), the method comprising:
sending planned path information indicating a plurality of planned locations of the UE to a master node (MN) of the dual connectivity.

### Supplementary Note 61

A radio access network (RAN) node configured to operate as a master node (MN) in dual connectivity for a User Equipment (UE), the RAN node comprising:
at least one memory; and
at least one processor coupled to the at least one memory and configured to send aerial UE subscription information regarding the UE or information derived therefrom to a secondary node (SN) of the dual connectivity.

### Supplementary Note 62

The RAN node according to Supplementary Note 61, wherein the aerial UE subscription information or the information derived therefrom indicates whether the UE or a user thereof is allowed to use aerial UE functionality, whether the UE is an aerial UE or not, or whether the UE supports aerial UE functionality or not.

### Supplementary Note 63

The RAN node according to Supplementary Note 61 or 62, wherein the at least one processor is configured to send the aerial UE subscription information or the information derived therefrom to the SN in an SN addition procedure.

### Supplementary Note 64

The RAN node according to any one of Supplementary Notes 61 to 63, wherein the at least one processor is configured to send the aerial UE subscription information or the information derived therefrom to the SN via an S-NODE ADDITION REQUEST message.

### Supplementary Note 65

The RAN node according to any one of Supplementary Notes 61 to 64, wherein the at least one processor is configured to send planned path information indicating a plurality of planned locations of the UE to the SN together with the aerial UE subscription information or the information derived therefrom.

### Supplementary Note 66

A method performed by a radio access network (RAN) node configured to operate as a master node (MN) in dual connectivity for a User Equipment (UE), the method comprising:
sending aerial UE subscription information regarding the UE or information derived therefrom to a secondary node (SN) of the dual connectivity.

### Supplementary Note 67

A program for causing a computer to perform a method for a radio access network (RAN) node configured to operate as a master node (MN) in dual connectivity for a User Equipment (UE), the method comprising:
sending aerial UE subscription information regarding the UE or information derived therefrom to a secondary node (SN) of the dual connectivity.

### Supplementary Note 68

A radio access network (RAN) node configured to operate as a secondary node (SN) in dual connectivity for a User Equipment (UE), the RAN node comprising:
at least one memory; and
at least one processor coupled to the at least one memory and configured to receive aerial UE subscription information regarding the UE or information derived therefrom from a master node (MN) of the dual connectivity.

### Supplementary Note 69

The RAN node according to Supplementary Note 68, wherein the aerial UE subscription information or the information derived therefrom indicates whether the UE or a user thereof is allowed to use aerial UE functionality, whether the UE is an aerial UE or not, or whether the UE supports aerial UE functionality or not.

### Supplementary Note 70

The RAN node according to Supplementary Note 68 or 69, wherein the at least one processor is configured to receive the aerial UE subscription information or the information derived therefrom from the MN in an SN addition procedure.

### Supplementary Note 71

The RAN node according to any one of Supplementary Notes 68 to 70, wherein the at least one processor is configured to receive the aerial UE subscription information or the information derived therefrom from the MN via an S-NODE ADDITION REQUEST message.

### Supplementary Note 72

The RAN node according to any one of Supplementary Notes 68 to 71, wherein the at least one processor is configured to receive planned path information indicating a plurality of planned locations of the UE from the MN together with the aerial UE subscription information or the information derived therefrom.

### Supplementary Note 73

A method performed by a radio access network (RAN) node configured to operate as a secondary node (SN) in dual connectivity for a User Equipment (UE), the method comprising:
receiving aerial UE subscription information regarding the UE or information derived therefrom from a master node (MN) of the dual connectivity.

### Supplementary Note 74

A program for causing a computer to perform a method for a radio access network (RAN) node configured to operate as a secondary node (SN) in dual connectivity for a User Equipment (UE), the method comprising:
receiving aerial UE subscription information regarding the UE or information derived therefrom from a master node (MN) of the dual connectivity.

### Supplementary Note 75

A radio access network (RAN) node comprising:
at least one memory; and
at least one processor coupled to the at least one memory and configured to determine one or more execution conditions for conditional mobility of a User Equipment (UE) based on planned path information indicating a plurality of planned locations of the UE.

### Supplementary Note 76

The RAN node according to Supplementary Note 75, wherein the planned path information is flight path information indicating a plurality of waypoints defined as three-dimensional locations.

### Supplementary Note 77

The RAN node according to Supplementary Note 75 or 76, wherein the UE is a UE with aerial UE functionality.

### Supplementary Note 78

The RAN node according to any one of Supplementary Notes 75 to 77, wherein the one or more execution conditions include a location of the UE being at a reference location, within a configured distance from a reference location, or within a reference area.

### Supplementary Note 79

The RAN node according to any one of Supplementary Notes 75 to 78, wherein the one or more execution conditions include reaching a scheduled time.

### Supplementary Note 80

The RAN node according to any one of Supplementary Notes 75 to 79, wherein the conditional mobility is a conditional handover, a conditional Primary Secondary Cell Group (SCG) Cell (PSCell) addition, an intra-secondary node (SN) conditional PSCell change, or an inter-SN conditional PSCell change.

### Supplementary Note 81

The RAN node according to Supplementary Note 80, wherein the RAN node is a source node in a conditional handover, a master node (MN) in a conditional PSCell addition, an SN in an intra-SN conditional SN change, a source SN in an SN-initiated inter-SN conditional PSCell change, or an MN in an MN-initiated inter-SN conditional PSCell change,

### Supplementary Note 82

A method performed by a radio access network (RAN) node, the method comprising:
determining one or more execution conditions for conditional mobility of a User Equipment (UE) based on planned path information indicating a plurality of planned locations of the UE.

### Supplementary Note 83

A program for causing a computer to perform a method for a radio access network (RAN) node, the method comprising:
determining one or more execution conditions for conditional mobility of a User Equipment (UE) based on planned path information indicating a plurality of planned locations of the UE.

### Supplementary Note 84

A radio access network (RAN) node comprising:
at least one memory; and
at least one processor coupled to the at least one memory and configured to:
   receive from a source RAN node a handover request of a User Equipment (UE) indicating one or more target cells; and
   if the handover request includes one or both of planned path information indicating a plurality of planned locations of the UE and an explicit indication that an alternative cell proposal is allowed, send a handover request response to the source RAN node indicating another cell that is acceptable for handover and is different from the one or more target cells.

### Supplementary Note 85

The RAN node according to Supplementary Note 84, wherein the at least one processor is configured to send the handover request response indicating the another cell to the source RAN node, provided at least that the handover request includes the planned path information indicating the plurality of planned locations of the UE.

### Supplementary Note 86

The RAN node according to Supplementary Note 84 or 85, wherein the at least one processor is configured to determine the another cell that is acceptable for handover based on the planned path information.

### Supplementary Note 87

The RAN node according to any one of Supplementary Notes 84 to 86, wherein the planned path information is flight path information indicating a plurality of waypoints defined as three-dimensional locations.

### Supplementary Note 88

The RAN node according to any one of Supplementary Notes 84 to 87, wherein the handover request is a request for a conditional handover.

### Supplementary Note 89

A method performed by a radio access network (RAN) node, the method comprising:
receiving from a source RAN node a handover request of a User Equipment (UE) indicating one or more target cells; and
if the handover request includes one or both of planned path information indicating a plurality of planned locations of the UE and an explicit indication that an alternative cell proposal is allowed, sending a handover request response to the source RAN node indicating another cell that is acceptable for handover and is different from the one or more target cells.

### Supplementary Note 90

A program for causing a computer to perform a method for a radio access network (RAN) node, the method comprising:
receiving from a source RAN node a handover request of a User Equipment (UE) indicating one or more target cells; and
if the handover request includes one or both of planned path information indicating a plurality of planned locations of the UE and an explicit indication that an alternative cell proposal is allowed, sending a handover request response to the source RAN node indicating another cell that is acceptable for handover and is different from the one or more target cells.

### Supplementary Note 91

A radio access network (RAN) node comprising:
at least one memory; and
at least one processor coupled to the at least one memory and configured to transmit, to a User Equipment (UE), information regarding support of aerial UEs in a neighboring cell or a neighboring frequency.

### Supplementary Note 92

A User Equipment (UE) comprising:
at least one memory; and
at least one processor coupled to the at least one memory and configured to receive, from a radio access network (RAN) node, information regarding support of aerial UEs in a neighboring cell or a neighboring frequency.

### Supplementary Note 93

The UE according to Supplementary Note 92, wherein the at least one processor is configured to determine, based on the information, a cell to attempt to reconnect to if reconnection of a radio link is required.

### Supplementary Note 94

The UE according to Supplementary Note 92 or 93, wherein the at least one processor is configured to consider the information in a cell reselection in a Radio Resource Control (RRC)_IDLE or RRC INACTIVE state.

### Supplementary Note 95

A radio access network (RAN) node comprising:
at least one memory; and
at least one processor coupled to the at least one memory and configured to transmit, to a User Equipment (UE), information about one or more future candidate cells associated with planned path information indicating a plurality of planned locations of the UE.

### Supplementary Note 96

The RAN node according to Supplementary Note 95, wherein the information about the one or more future candidate cells indicates information about a recommended cell at each of the plurality of locations included in the planned path information.

### Supplementary Note 97

A User Equipment (UE) comprising:
at least one memory; and
at least one processor coupled to the at least one memory and configured to receive, from a radio access network (RAN) node, information about one or more future candidate cells associated with planned path information indicating a plurality of planned locations of the UE.

### Supplementary Note 98

The UE according to Supplementary Note 97, wherein the information about the one or more future candidate cells indicates information about a recommended cell at each of the plurality of locations included in the planned path information.

### Supplementary Note 99

The UE according to Supplementary Note 97 or 98, wherein the at least one processor is configured to determine, based on the information about the one or more future candidate cells, a cell to attempt to reconnect to if reconnection of a radio link is required.

### Supplementary Note 100

The UE according to Supplementary Note 97 or 98, wherein the at least one processor is configured to consider the information about the one or more future candidate cells in a cell reselection in a Radio Resource Control (RRC)_IDLE or RRC_INACTIVE state.

### Supplementary Note 101

A network node comprising:
at least one memory; and
at least one processor coupled to the at least one memory and configured to transmit, to a User Equipment (UE), emergency landing point information associated with planned path information indicating a plurality of planned locations of the UE.

### Supplementary Note 102

The network node according to Supplementary Note 101, wherein the emergency landing point information indicates location information of one or more points where emergency landing is permitted or recommended for each of the plurality of planned locations.

### Supplementary Note 103

The network node according to Supplementary Note 101, wherein the emergency landing point information indicates location information of one or more points in a serving cell of the UE or in a location registration area of the UE, or associated with the serving cell or the location registration area, where emergency landing is permitted or recommended.

### Supplementary Note 104

The network node according to any one of Supplementary Notes 101 to 103, wherein the network node is a radio access network (RAN) node or core network node.

### Supplementary Note 105

A User Equipment (UE) comprising:
at least one memory; and
at least one processor coupled to the at least one memory and configured to receive, from a radio access network (RAN) node or from a core network node via the RAN node, emergency landing point information associated with planned path information indicating a plurality of planned locations of the UE.

### Supplementary Note 106

The UE according to Supplementary Note 105, wherein the emergency landing point information indicates location information of one or more points where emergency landing is permitted or recommended for each of the plurality of planned locations.

### Supplementary Note 107

The UE according to Supplementary Note 105, wherein the emergency landing point information indicates location information of one or more points in a serving cell of the UE or in a location registration area of the UE, or associated with the serving cell or the location registration area, where emergency landing is permitted or recommended.

### Supplementary Note 108

The UE according to any one of Supplementary Notes 105 to 107, wherein the at least one processor is configured to determine a target point at which to attempt an emergency landing based on the emergency landing point information.

This application is based upon and claims the benefit of priority from Japanese Patent Application No. 2022-118616, filed on Jul. 26, 2022, the disclosure of which is incorporated herein in its entirety by reference.

### REFERENCE SIGNS LIST

1 Master Node (MN)
2 Source Secondary Node (S-SN)
3 User Equipment (UE)
4 Target Secondary Node (T-SN)
6 Source RAN node
7 Target RAN node
2104 Processor
2105 Memory
2203 Baseband processor
2204 Application processor
2206 Memory
2207 Modules

What is claimed is:

1-108. (canceled)

109. A method of a User Equipment (UE), the method comprising:
receiving a configuration associated with a beam corresponding to an altitude from a Radio Access Network (RAN) node; and
selecting a beam based on information about an altitude and the configuration.

110. The method according to claim 109, wherein the configuration is transmitted in a configuration associated with a measurement report which is used in a procedure associated with a mobility.

111. The method according to claim 109, wherein the UE has an aerial UE function.

112. A method of a first Radio Access Network (RAN) node, the method comprising:
transmitting information about a flight path of a User Equipment (UE) to a second RAN node in a procedure associated with a mobility of the UE; and
transmitting a configuration associated with a beam corresponding to an altitude to the UE.

113. The method according to claim 112, wherein the configuration is transmitted in a configuration associated with a measurement report which is used in the procedure associated with a mobility.

114. The method according to claim 112, wherein the configuration causes the UE to select a beam corresponding to an altitude of the UE.

115. A User Equipment (UE) comprising:
at least one memory; and
at least one processor coupled to the at least one memory and configured to:
receive a configuration associated with a beam corresponding to an altitude from a Radio Access Network (RAN) node; and
select a beam based on information about an altitude and the configuration.

116. The UE according to claim 115, wherein the configuration is transmitted in a configuration associated with a measurement report which is used in a procedure associated with a mobility.

117. The UE according to claim 115, wherein the UE has an aerial UE function.
